(19) United States
(12) Patent Application Publication
(10) Pub. No.: US 2024/0408717 A1
(43) Pub. Date: Dec. 12, 2024

(54) Hand-Held Power Tool, in Particular Grinding Tool, Hand-Held Power Tool Apparatus, Protective Device, Hand-Held Power Tool System and Method for Producing a Hand-Held Power Tool Apparatus

(71) Applicant: Robert Bosch GmbH, Stuttgart (DE)

(72) Inventors: Daniel Barth, Leinfelden-Echterdingen (DE); Florian Esenwein, Leinfelden-Echterdingen (DE)

(21) Appl. No.: 18/736,167

(22) Filed: Jun. 6, 2024

(30) Foreign Application Priority Data
Jun. 9, 2023 (DE) 10 2023 205 366.7

(51) Int. Cl. B24B 23/03; B24B 55/10; B25F 5/00

(52) U.S. Cl. CPC B24B 23/03; B24B 55/102; B25F 5/006

(57) ABSTRACT

A hand-held power tool includes a housing unit which has at least one handle housing and a drive housing which is coupled to the handle housing, and a central web on a surface of an upper side of the drive housing, and raised relative to the surface.

This application claims priority under 35 U.S.C. § 119 to application no. 10 2023 205 366.7, filed on Jun. 9, 2023 in Germany, the disclosure of which is incorporated herein by reference in its entirety.

The present disclosure relates to a hand-held power tool apparatus for a hand-held power tool having a housing unit, which has at least one handle housing and one drive housing, said drive housing being coupled to the handle housing, has already been proposed.

### SUMMARY

The disclosure proceeds from on a hand-held power tool apparatus, in particular a hand-held grinding tool apparatus, for a hand-held power tool, in particular a grinding tool, preferably a random orbital sander or an orbital sander, having a housing unit which has at least one handle housing and a drive housing which is coupled to the handle housing.

It is proposed that the drive housing has a central web on a surface of an upper side of the drive housing said central web being raised relative to the surface, above which, in particular, one end of the handle housing is arranged, wherein the central web slopes down onto the surface in both directions starting from a main extension plane of the handle housing and perpendicular to the main extension plane of the handle housing.

Advantageously, a design of the drive housing with such a central web provides a particularly space-saving design of the hand-held power tool apparatus, especially with regard to the overall height of the hand-held power tool. A particularly large gripping surface can be realized on the handle housing. Advantageously, contact between the operator's fingers and the drive housing can be effectively counteracted. The operator can be protected particularly effectively against vibrations. Advantageously, a particularly high level of operating comfort can be achieved. Particularly precise and/or safe guidance of the hand-held power tool can be enabled.

In particular, the central web is raised from the adjacent surface. A maximum transverse extension of the central web is preferably smaller than a maximum overall transverse extension of the handle housing. The maximum transverse extension of the central web preferably runs at least substantially perpendicular to a main extension plane of the bow handle, the main extension plane of the handle housing, a separation plane of the handle housing and/or a drive axis of the drive unit. A “main extension plane” of a structural unit or an element can in particular be understood to be a plane which is parallel to a largest lateral surface of a smallest possible notional cuboid which just completely encloses the structural unit, and in particular runs through the midpoint of the cuboid. In particular, the maximum transverse extension of the central web runs at least substantially parallel to a tool holder surface of a tool holder of the hand-held power tool, in particular the grinding tool. The maximum transverse extension of the central web is preferably smaller than a maximum transverse extension of the handle housing at the end of the central web arranged above the central web. In particular, the end of the handle housing is arranged above the central web relative to the tool holder and/or the surface.

The central web preferably has a main extension axis. The “main extension axis” of an object can be understood in particular as an axis that runs parallel to a longest edge of a smallest geometric cuboid that just completely encloses the object and, in particular, runs through the center of the cuboid. In particular, the main extension axis of the central web runs at least substantially perpendicular to the drive axis and/or to the maximum transverse extension of the central web. In particular, the main extension axis of the central web runs at least substantially parallel to the main extension plane of the bow handle, to the main extension plane of the handle housing, to the separation plane and/or to the tool holder surface. Preferably, the main extension axis of the central web runs in the main extension plane of the bow handle, in the main extension plane of the handle housing and/or in the separation plane.

The central web runs, preferably at least in the direction of the main extension axis of the central web, in particular over a large part of the surface, preferably over at least 50%, preferably over at least 75% and particularly preferably over 90% of the surface. The upper side, preferably the surface, is arranged in particular facing away from the tool holder. The central web has a curvature, preferably a curvature adapted to the surface, in particular in the longitudinal direction, preferably in the direction of the main extension axis of the central web. Alternatively, however, it is also conceivable that the central web has no curvature in the longitudinal direction.

In one aspect of the disclosure, which can be considered in particular on its own as well as in conjunction with other aspects of the disclosure, the disclosure is based on a grinding tool, in particular a battery-powered grinding tool, in particular as previously mentioned, with a tool holder, in particular as previously mentioned, in particular a sanding pad, with a drive unit for driving the tool holder and with a housing unit, in particular as previously mentioned, which has a bow handle, in particular as previously mentioned.

It is proposed that a ratio of a maximum longitudinal extension of a handle recess of the bow handle to a maximum longitudinal extension of the tool holder is at least 0.35 and at most 0.5. Advantageously, a grinding tool with particularly favorable ergonomic properties can be provided. Advantageously, particularly depending on the size of the tool holder, a particularly large amount of space can be provided for an operator's fingers in the handle recess for guiding the grinding tool. Particularly precise and/or safe handling of the grinding tool can be realized. Advantageously, a particularly high level of operating comfort can be achieved.

The grinding tool is preferably designed as a battery-operated grinding tool. Alternatively, however, it is also conceivable that the grinding tool is designed as a mains-powered grinding tool. The grinding tool is preferably designed as a random orbital sander. Alternatively, however, it is also conceivable that the grinding tool is designed as an orbital sander, a delta sander, a mini-random orbital sander or the like.

The tool holder is preferably designed as a sanding pad. The tool holder is preferably designed as a round sanding pad. Alternatively, however, it is also conceivable that the tool holder is designed as a delta pad, as a square, preferably rectangular, sanding pad or as another sanding pad that appears useful to a person skilled in the art. In particular, the tool holder has fastening means for fastening a tool, preferably an abrading medium. The fastening means comprise, for example, one or more hook-and-loop surface, one or more clips, a combination of these or other fastening means that would appear useful to a person skilled in the art. The abrading medium is preferably designed as a sandpaper, an abrasive fleece, an abrasive grid or the like.

In particular, the drive unit has a drive element, preferably an eccentric. The drive element is preferably designed to be driven around the drive axis of the drive unit. The grinding tool preferably has an output unit. In particular, the tool holder is part of the output unit. The output unit preferably has a connecting piece. The connecting piece is arranged on the drive element, preferably attached. The tool holder is preferably attached to the connecting piece, in particular in a rotationally fixed manner, for example by means of a screw or the like. In particular, the output element has an output axis. The output axis preferably runs at least substantially parallel to the drive axis. In particular, the drive axis is at a distance from the output axis. “Substantially parallel” can be understood here to mean an orientation of a direction relative to a reference direction, in particular in a plane, wherein the direction has a deviation relative to the reference direction that is in particular less than 8°, advantageously less than 5° and particularly advantageously less than 2°. In particular, the connecting piece and/or the tool holder, preferably the output axis, moves in at least one operating state around the drive axis, preferably in a circular motion. In particular, the drive element is intended to drive the connecting piece and/or the tool holder, preferably the output axis, to a, preferably circular, movement around the drive axis of the drive element.

“Provided” is understood as meaning specifically adapted, specifically designed and/or specifically equipped. The phrase “an object being provided for a specific function” is intended to mean that the object fulfills and/or performs this specific function in at least one application- and/or operating state.

The connecting piece is preferably attached to the drive element so that it can rotate, in particular about the output axis. The grinding tool preferably has at least one bearing element. In particular, the connecting piece is mounted on the drive element so that it can rotate via the bearing element, preferably about the output axis. The bearing element is preferably arranged between the drive element and the connecting piece. The bearing element is preferably designed as a radial bearing, in particular as a rolling bearing, for example as a ball bearing, or as a plain bearing.

The drive unit is preferably provided to drive the output unit, in particular the tool holder. The drive unit preferably has an electric motor or the like, in particular for driving the drive element.

The grinding tool preferably has a housing unit. The housing unit preferably has a drive housing to accommodate the drive unit. The drive housing preferably has a fan housing to accommodate an extraction fan. Preferably, the extraction fan is designed to extract the material removed from the workpiece during machining and, in particular, to blow it out of a dust outlet of the grinding tool. The drive housing preferably has a motor housing to accommodate the drive unit. The fan housing is preferably arranged between the motor housing and the tool holder. The extraction fan is preferably made of metal, especially cast. Alternatively, however, it is also conceivable that the extraction fan is made of plastic or a combination of plastic and metal.

In particular, the housing unit has a handle housing. Preferably, the bow handle is part of the handle housing. The handle housing preferably has two handle housing shells, which are connected to each other in particular in the separation plane of the handle housing. The handle housing is preferably designed separately from the drive housing, in particular at a distance from the drive housing. In particular, the handle housing has a shell construction with the two handle housing shells as half shells.

The bow handle preferably has a finger grip surface. The bow handle preferably has two walls, in particular lateral walls, which delimit the finger grip surface, in particular in the main extension plane of the bow handle and viewed in a direction perpendicular to the drive axis. Preferably, the bow handle is designed as a closed bow handle. Alternatively, however, it is also conceivable that the bow handle is designed as an open bow handle. Preferably, the walls define, in particular limit, the handle recess at least partially.

The maximum longitudinal extension of the handle recess preferably runs at least substantially parallel to the tool holder surface of the tool holder. The maximum longitudinal extension of the handle recess preferably runs in the main extension plane of the bow handle, preferably in the main extension plane of the handle housing, in particular in the separation plane of the handle housing. Preferably, the main extension plane of the bow handle corresponds to the main extension plane of the handle housing. Alternatively, it is conceivable that the main extension plane of the bow handle is different from the main extension plane of the handle housing. The separation plane is preferably congruent with the main extension plane of the handle housing and/or the main extension plane of the bow handle. Alternatively, however, it is also conceivable that the main extension plane of the bow handle and/or the main extension plane of the handle housing are/is different from the separation plane.

The tool holder surface preferably runs at least substantially perpendicular to the separation plane, the main extension plane of the handle housing and/or the main extension plane of the bow handle. “Substantially perpendicular” can be understood to mean an orientation of a direction relative to a reference direction, wherein, in particular viewed in a projection plane, the direction and the reference direction enclose an angle of 90° and the angle has a maximum deviation of in particular less than 8°, advantageously less than 5° and particularly advantageously less than 2°.

In particular, the maximum longitudinal extension of the tool holder runs at least substantially parallel to the maximum longitudinal extension of the handle recess and/or the tool holder surface. The maximum longitudinal extension of the tool holder preferably runs in the separation plane of the handle housing, the main extension plane of the handle housing and/or in the main extension plane of the bow handle. The maximum longitudinal extension of the tool holder is defined in particular by a maximum longitudinal extension of the tool holder surface. In particular, the tool is intended to be arranged on the tool holder surface.

Preferably, the ratio of the maximum longitudinal extension of the handle recess of the bow handle to the maximum longitudinal extension of the tool holder is at least 0.38. Preferably, the ratio of the maximum longitudinal extension of the handle recess of the bow handle to the maximum longitudinal extension of the tool holder is at most 0.42. Particularly preferably, the ratio of the maximum longitudinal extension of the handle recess of the bow handle to the maximum longitudinal extension of the tool holder is at least substantially 0.4. The maximum longitudinal extension of the handle recess is preferably at least 50 mm, preferably at least 55 mm and particularly preferably at least 60 mm. The maximum longitudinal extension of the handle recess is preferably a maximum of 80 mm, preferably a maximum of 70 mm and particularly preferably a maximum of 75 mm. Particularly preferably, the maximum longitudinal extension of the handle recess is at least substantially 61 mm. Alternatively, however, it is also conceivable that the maximum longitudinal extension of the handle recess is greater than 80 mm or less than 50 mm.

In particular, the handle housing has a palm handle, particularly a handle knob. The palm handle is preferably arranged such that the drive axis intersects the palm handle. In particular, the bow handle merges into the palm handle. The fan housing is arranged in particular between the tool holder and the palm handle. The handle housing, in particular the palm handle, surrounds the motor housing, preferably at least in a plane perpendicular to the drive axis.

The grinding tool preferably has a battery pack interface for electrical and/or mechanical connection to a battery pack. In particular, the battery pack interface has guide means, for example one or more guide rails or the like, for guiding the battery pack during assembly and/or disassembly at the battery pack interface. The battery pack interface, in particular the guide means, preferably specify an insertion direction for the battery pack when the battery pack is mounted on the battery pack interface. The insertion direction preferably runs at least substantially perpendicular to the drive axis, to the separation plane, to the main extension plane of the bow handle and/or to the main extension plane of the handle housing. In particular, the insertion direction runs at least substantially parallel to the tool holder surface. Preferably, the battery pack interface is arranged on the handle housing, in particular on a side of the bow handle facing away from the palm handle. The battery pack interface is in particular free from an interface with the drive axis and/or a main extension plane of the tool holder surface.

Preferably, the hand-held power tool, in particular the grinding tool, has at least one input element. Preferably, the hand-held power tool can be switched on and/or off by the operator actuating the input element. Alternatively or additionally, it is conceivable that a rotational speed of the hand-held power tool can be adjusted or the like by means of the input element. The input element can, for example, be designed as a button, a rotary wheel, a switch or the like. The input element is arranged, for example, on the palm handle, preferably on a side of the palm handle facing away from the battery pack interface, the tool holder and/or the bow handle.

The grinding tool is preferably intended to be guided with one hand, in particular by means of the bow handle and the palm handle. Alternatively, however, it is also conceivable that the grinding tool is designed as a two-handed guide, wherein in each case one hand of the operator is arranged on the palm handle and one on the bow handle.

In one aspect of the disclosure, which can be considered in particular on its own as well as in conjunction with other aspects of the disclosure, the disclosure is based on a hand-held power tool apparatus, in particular a hand-held grinding tool apparatus, for a hand-held power tool, in particular a grinding tool, preferably as previously mentioned, with a housing unit, in particular as previously mentioned, which has at least one, in particular as previously mentioned, handle housing and a drive housing, in particular as previously mentioned, which is coupled to the handle housing. It is proposed that the drive housing has, on a surface of an upper side of the drive housing, a central web which is raised relative to the surface and above which, in particular, one end of the handle housing is arranged, wherein the central web slopes down onto the surface in both directions, starting from a main extension plane of the handle housing, in particular the main extension plane of the handle housing already mentioned above, and perpendicular to the main extension plane of the handle housing.

Advantageously, a design of the drive housing with such a central web provides a particularly space-saving design of the hand-held power tool apparatus, especially with regard to the overall height of the hand-held power tool. A particularly large gripping surface can be realized on the handle housing. Advantageously, contact between the operator's fingers and the drive housing can be effectively counteracted. The operator can be protected particularly effectively against vibrations. Advantageously, a particularly high level of operating comfort can be achieved. Particularly precise and/or safe guidance of the hand-held power tool can be enabled.

In particular, the central web is raised from the adjacent surface. A maximum transverse extension of the central web is preferably smaller than a maximum overall transverse extension of the handle housing. The maximum transverse extension of the central web preferably runs at least substantially perpendicular to the main extension plane of the bow handle, the main extension plane of the handle housing, the separation plane and/or the drive axis. In particular, the maximum transverse extension of the central web runs at least substantially parallel to the tool holder surface of the tool holder. The maximum transverse extension of the central web is preferably smaller than a maximum transverse extension of the handle housing at the end of the central web arranged above the central web. In particular, the end of the handle housing is arranged above the central web relative to the tool holder and/or the surface.

The central web preferably has a main extension axis. The “main extension axis” of an object can be understood in particular as an axis that runs parallel to a longest edge of a smallest geometric cuboid that just completely encloses the object and, in particular, runs through the center of the cuboid. In particular, the main extension axis of the central web runs at least substantially perpendicular to the drive axis and/or to the maximum transverse extension of the central web. In particular, the main extension axis of the central web runs at least substantially parallel to the main extension plane of the bow handle, to the main extension plane of the handle housing, to the separation plane and/or to the tool holder surface. Preferably, the main extension axis of the central web runs in the main extension plane of the bow handle, in the main extension plane of the handle housing and/or in the separation plane.

The central web runs, preferably at least in the direction of the main extension axis of the central web, in particular over a large part of the surface, preferably over at least 50%, preferably over at least 75% and particularly preferably over 90% of the surface. The upper side, preferably the surface, is arranged in particular facing away from the tool holder. The central web has a curvature, preferably a curvature adapted to the surface, in particular in the longitudinal direction, preferably in the direction of the main extension axis of the central web. Alternatively, however, it is also conceivable that the central web has no curvature in the longitudinal direction.

In one aspect of the disclosure, which can be considered in particular on its own as well as in conjunction with other aspects of the disclosure, the disclosure is based on a hand-held power tool system with a grinding tool, in particular the grinding tool already mentioned above, preferably an orbital sander or a random orbital sander, and with a battery pack for supplying power to the grinding tool. It is proposed that the hand-held power tool system has a support unit which is designed for parking and/or resting the grinding tool on a substrate in at least one parking and/or resting position, wherein the battery pack has a support surface of the support unit for the at least one parking and/or resting position.

Advantageously, a secure stand of the grinding tool can be achieved via the battery pack. Advantageously, an operator can conveniently park the grinding tool. An operator can park or set down the grinding tool via the battery pack for cleaning, maintenance or the like of the hand-held power tool and/or a tool arranged on the grinding tool. A particularly high level of operating convenience can be achieved.

It is conceivable that a support point or a support line forms the support surface. It is also conceivable that the support surface comprises several support points, in particular spaced apart from one another. Preferably, the support surface is a continuous surface that rests on the substrate, particularly in the at least one parking and/or resting position. The substrate can be a floor, a table or similar. In particular, the battery pack has a rechargeable battery pack housing. The rechargeable battery pack housing has the support surface.

It is conceivable that the support unit is designed for parking and/or resting the grinding tool on the substrate in at least one further parking and/or resting position. By way of example, the battery pack has a further support surface of the support unit for the at least one further parking and/or resting position. It is also conceivable that the housing unit, in particular the handle housing and/or the drive housing, has at least one additional support surface for the parking and/or resting position and/or for the at least one further parking and/or resting position.

In one aspect of the disclosure, which can be considered in particular on its own as well as in conjunction with other aspects of the disclosure, the disclosure is based on a protective device, in particular a wall protection ring, for collision protection of a tool, in particular the tool(s) already mentioned above, which can be arranged on the hand-held power tool and/or a tool holder, in particular a sanding pad, of the hand-held power tool with objects in a working environment of the hand-held power tool. It is proposed that the protective device has an screen unit and/or a light guide unit for at least one light source.

A particularly efficient and/or precise illumination of a workpiece to be processed by means of the hand-held power tool can be realized. Such a design of the hand-held power tool apparatus can counteract blinding of the operator. Advantageously, a particularly high level of operating comfort and/or a particularly high level of operating safety can be realized.

The protective device is designed in particular as a protective ring. The protective device is preferably provided as a bumper for the hand-held power tool. In particular, the protective device is intended to counteract an impact of the tool holder and/or the tool arranged on the tool holder against walls or the like in the working environment. The protective device is preferably arranged on the drive housing in at least one operating state. Preferably, the protective device is intended to be arranged on the fan housing.

The screen unit is provided in particular for shielding an area from the incidence of light from the at least one light source. By way of example, the screen unit has at least one screen element. Alternatively, however, it is also conceivable that the screen unit has several screen elements. The screen element is preferably an opaque component. It is conceivable that the screen element is designed as a reflector, for example as a mirror, or the like.

The protective device preferably has a base element. It is conceivable that the screen unit, in particular the at least one screen element, is formed in one piece with the base element. It is conceivable that the screen unit, in particular the at least one screen element, is formed by the base element of the protective device. Alternatively, it is also conceivable that the screen unit, in particular the at least one screen element, is formed separately from the base element. In particular, it is conceivable that the screen unit, preferably the at least one screen element, can be attached to the base element, preferably detachably. In this context, “detachable” is to be understood in particular as “non-destructively separable”. It is also conceivable that the screen unit, in particular the at least one screen element, can be arranged adjustably on the base element, preferably in order to adapt a cut-off area by the screen unit.

The light guide unit is preferably arranged on the base element and/or the screen unit. By way of example, the light guide unit has at least one light guide element and preferably several light guide elements. In particular, the light guide unit is intended to guide and/or emit light from the at least one light source. The at least one light guide element is designed, for example, as a transparent fiber, tube or rod. It is also conceivable that the light guide unit has at least one emitting element, in particular a light-scattering element, for example in the form of a roughening, a scattering glass, plastic or ceramic plate, a scattering plastic film or the like. The emitting element is preferably arranged on the base element and/or the screen unit. It is also conceivable that the emitting element is part of the light guide element or forms the light guide element.

The at least one light source is, for example, part of the hand-held power tool, in particular the grinding tool. Alternatively or additionally, however, it is also conceivable that the light source is part of the protective device. The light source is designed, for example, as an LED, as an incandescent lamp or as another illuminant that appears useful to a person skilled in the art.

In one aspect of the disclosure, which can be considered in particular on its own as well as in conjunction with other aspects of the disclosure, the disclosure is based on a hand-held power tool apparatus, in particular as previously mentioned, with a housing unit, in particular as previously mentioned, which comprises a handle housing, in particular as previously mentioned, and a handle housing, in particular as previously mentioned, housing and a drive housing, in particular the aforementioned drive housing, for accommodating a drive unit, preferably the aforementioned drive unit, wherein the drive housing defines a drive axis, in particular the aforementioned drive axis, of the drive unit, and with a damping unit which couples the drive housing to the handle housing. It is proposed that the drive housing has a cantilever which extends at least radially relative to the drive axis and on which at least part of the damping unit is arranged.

Advantageously, a particularly efficient decoupling of the handle housing from vibrations on the drive housing can be achieved with particularly precise and/or comfortable hand tool guidance at the same time. A particularly high level of operating convenience can be achieved. Advantageously, a particularly wide support of the drive housing on the handle housing can be achieved. Advantageously, a particularly stable guidance of the hand-held power tool can be achieved. A particularly high level of operating safety can be achieved.

In particular, the motor housing provides the drive axis. Preferably, the motor housing has a motor mount with a motor axis located in its central longitudinal axis. The drive axis is defined in particular by the motor axis. In particular, the central longitudinal axis is congruent with the drive axis.

The damping unit preferably has several damping elements. The damping elements are preferably made of at least one elastic material, in particular an elastic plastic. The damping elements can be in the form of blocks, rings, ring segments, plates or the like. The drive housing is preferably connected to the handle housing via the damping elements. The damping unit is provided in particular for vibration decoupling of the handle housing from the drive housing. The handle housing is preferably only connected to the drive housing via the damping unit, in particular the damping elements of the damping unit.

At least some of the damping elements can preferably be fixed between the drive housing and the handle housing via a clamping mechanism. It is also conceivable that the damping elements have an adhesive layer for attachment to the drive housing and/or to the handle housing. Additionally or alternatively, it is conceivable that at least some of the damping elements can be attached to the handle housing and/or the drive housing by means of damping element holders, for example recesses, retaining bolts or the like, and/or by means of a screw connection or the like.

In particular, the handle housing is coupled to the drive housing via two different coupling regions of the damping unit. Preferably, the handle housing has two inner regions, in particular mutually spaced, in each of which a part of the drive housing is arranged. In particular, the two coupling regions are arranged in the two inner regions.

The cantilever is preferably arranged on a side of the drive housing facing the battery pack interface. The cantilever is preferably arranged inside the handle housing, in particular in an inner region of the two inner regions of the handle housing. The cantilever forms an outermost point of the drive housing, in particular when viewed in a direction perpendicular to the drive axis and extending in the separation plane. The cantilever is preferably at least partially enclosed by the handle housing.

The part of the damping unit arranged on the cantilever has, in particular, at least one damping element of the damping elements. The cantilever preferably has at least one damping element holder for the at least one damping element. The shape of the damping element is preferably adapted to the damping element holder. The damping element holder is designed, for example, as a retaining bolt, in particular for accommodating an annular damping element. The damping element holder is provided, for example, to accommodate the at least one damping element perpendicular to the main extension plane of the handle housing, in particular to the main extension plane of the bow handle, and/or to the separation plane. The cantilever is T-shaped, for example, in particular to accommodate at least two damping elements. Alternatively, however, it is also conceivable, for example, that the damping element holder is designed as a recess, in particular for accommodating a damping element designed as a block, plate or the like. It is conceivable that the at least one damping element is fixed to the damping element holder by the handle housing, in particular the handle housing shells. Alternatively or additionally, however, it is also conceivable that the damping element is glued, screwed or the like to the damping element holder.

In one aspect of the disclosure, which can in particular be considered independently of further aspects of the disclosure, it is proposed that a center of gravity of the grinding tool is arranged in the handle recess of the bow handle. Advantageously, a particularly high level of comfort can be achieved when handling the hand tool. Advantageously, a particularly favorable weight distribution can be achieved. Particularly favorable ergonomic properties can be achieved. Preferably, the center of gravity is arranged within the handle recess at least in a direction perpendicular to the main extension plane of the bow handle, in particular to the main extension plane of the handle housing. A minimum distance of the center of gravity from the separation plane of the handle housing, from the main extension plane of the handle housing and/or from the main extension plane of the bow handle is preferably smaller than a maximum transverse extension of the handle housing, in particular of the bow handle, starting from the separation plane of the handle housing, the main extension plane of the handle housing or the main extension plane of the bow handle. It is also conceivable that the center of gravity is located in the separation plane of the handle housing, in the main extension plane of the handle housing and/or in the main extension plane of the bow handle. The maximum transverse extension of the handle housing, in particular of the bow handle, preferably starting from the separation plane of the handle housing, the main extension plane of the handle housing and/or the main extension plane of the bow handle, preferably runs at least substantially perpendicular to the main extension plane of the bow handle, in particular to the main extension plane of the handle housing, the separation plane and/or to the drive axis. The maximum transverse extension of the handle housing, in particular of the bow handle, preferably starting from the separation plane of the handle housing, the main extension plane of the handle housing and/or the main extension plane of the bow handle, preferably runs at least substantially parallel to the tool holder surface.

Furthermore, it is proposed that a ratio of a maximum distance of the tool holder from the center of gravity in the direction of the drive axis to a minimum distance between the drive axis and the center of gravity is at least 2.8 and at most 3.5. Advantageously, a particularly favorable weight distribution can be achieved with regard to handling and/or guiding the hand-held power tool. A particularly high level of operating comfort and/or particularly favorable ergonomic properties of the grinding tool can be realized. Preferably, the ratio of the maximum distance of the tool holder from the center of gravity in the direction of the drive axis to the minimum distance between the drive axis and the center of gravity is at least 3.0, particularly preferably at least 3.1. Preferably, the ratio of the maximum distance of the tool holder from the center of gravity in the direction of the drive axis to the minimum distance between the drive axis and the center of gravity is at most 3.2. The maximum distance of the tool holder to the center of gravity in the direction of the drive axis is defined in particular by a maximum distance of the tool holder surface to the center of gravity in the direction of the drive axis. The maximum distance of the tool holder to the center of gravity in the direction of the drive axis is in particular at least 30 mm, preferably at least 33 mm, preferably at least 35 mm. The maximum distance between the tool holder and the center of gravity in the direction of the drive axis is in particular at most 50 mm, preferably at most 45 mm and particularly preferably at most 40 mm. By way of example, the maximum distance between the tool holder and the center of gravity in the direction of the drive axis is at least substantially 38 mm. Alternatively, however, it is also conceivable that the maximum distance between the tool holder and the center of gravity in the direction of the drive axis is less than 30 mm or greater than 50 mm. The minimum distance between the drive axis and the center of gravity is in particular at least 8 mm, preferably at least 10 mm. The minimum distance between the drive axis and the center of gravity is in particular at most 20 mm, preferably at most 15 mm. By way of example, the minimum distance between the drive axis and the center of gravity is at least substantially 12 mm. Alternatively, however, it is also conceivable that the minimum distance of the drive axis to the center of gravity is less than 8 mm or greater than 20 mm. In particular, the drive axis runs at least substantially perpendicular to the tool holder surface. In particular, the drive axis runs at least substantially parallel to the main extension plane of the handle housing, in particular to the main extension plane of the bow handle, and/or to the separation plane. It is conceivable that the drive axis runs in the main extension plane of the handle housing, in the main extension plane of the bow handle and/or in the separation plane. In particular, the minimum distance between the drive axis and the center of gravity runs at least substantially perpendicular to the drive axis. The minimum distance between the drive axis and the center of gravity runs in particular at least substantially parallel to the tool holder surface, to the main extension plane of the handle housing, to the main extension plane of the bow handle and/or to the separation plane.

It is also proposed that a maximum height of the grinding tool in the direction of the drive axis has a ratio of at least 2.8 and at most 3.2 to a maximum distance between the tool holder and the center of gravity in the direction of the drive axis, in particular that already mentioned above. Advantageously, the center of gravity of the hand-held power tool is particularly low with respect to the maximum height of the grinding tool. Advantageously, a particularly favorable weight distribution and/or particularly favorable ergonomic properties can be achieved with regard to handling and/or guiding the hand-held power tool. A particularly high level of operating convenience can be achieved. Advantageously, a particularly high stability of the grinding tool can be achieved. The ratio of the maximum height of the grinding tool in the direction of the drive axis to the maximum distance between the tool holder surface and the center of gravity in the direction of the drive axis is preferably at least 3.0. The ratio of the maximum height of the grinding tool in the direction of the drive axis to the maximum distance between the tool holder surface and the center of gravity in the direction of the drive axis is preferably at most 3.1. The maximum height of the grinding tool in the direction of the drive axis preferably runs from the tool holder surface parallel to the drive axis to an outermost point of the handle housing. The maximum height of the grinding tool is preferably at least 100 mm, preferably at least 110 mm. The maximum height of the grinding tool is preferably a maximum of 130 mm, preferably a maximum of 120 mm. Alternatively, however, it is also conceivable that the maximum height of the grinding tool in the direction of the drive axis is less than 110 mm or greater than 130 mm. A ratio of the maximum height of the grinding tool to a maximum height of the handle recess in a direction parallel to the drive axis is preferably at least 4.0, preferably at least 4.3, particularly preferably at least 4.4, and at most 5.0, preferably at most 4.7, particularly preferably at most 4.6. The maximum height of the handle recess is preferably between 20 mm and 30 mm, preferably between 24 mm and 28 mm and particularly preferably at least substantially 26 mm.

It is further proposed that the handle recess of the bow handle is closed, preferably substantially closed in an oval shape. Advantageously, the operator's fingers can be protected particularly effectively. Advantageously, the handle housing can be additionally supported by the closed bow handle. A particularly high stability of the hand-held power tool can be realized. In particular, the handle recess is closed when viewed in the main extension plane of the bow handle, in the main extension plane of the handle housing and/or in the separation plane. The handle recess is closed in particular by walls of the drive housing, in particular the fan housing of the drive housing, and the handle housing. Alternatively, it is conceivable that the handle recess is completely closed by walls of the handle housing. The handle recess preferably has an oval shape, in particular when viewed in a direction perpendicular to the main extension plane of the handle housing, preferably to the main extension plane of the handle housing. Alternatively, however, it is also conceivable that the handle recess has a rectangular shape, a square shape, a circular shape, or another shape that would appear useful to a person skilled in the art, in particular when viewed in the direction perpendicular to the main extension plane of the bow handle, preferably to the main extension plane of the handle housing.

It is further proposed that the battery pack has a center of gravity of the battery pack which, when arranged on the grinding tool, is offset from the main extension plane of the bow handle. Advantageously, design-related shifts in the center of gravity of the grinding tool with respect to the main extension plane of the bow handle can be compensated. A hand-held power tool system with a particularly favorable weight distribution can be provided. Advantageously, a particularly ergonomic hand-held power tool system can be provided. A particularly high level of operating convenience can be achieved. A minimum distance of the center of gravity of the battery pack from the separation plane of the handle housing, from the main extension plane of the handle housing and/or from the main extension plane of the bow handle is preferably smaller than the maximum transverse extension of the handle housing, in particular of the bow handle, starting from the separation plane of the handle housing, the main extension plane of the handle housing or the main extension plane of the bow handle. In particular, the minimum distance of the center of gravity of the battery pack from the separation plane of the handle housing, from the main extension plane of the handle housing and/or from the main extension plane of the bow handle is less than 20 mm, preferably less than 15 mm and preferably less than 10 mm.

In addition, it is proposed that the grinding tool has a dust outlet, in particular the dust outlet already mentioned above, wherein the center of gravity of the battery pack and the dust outlet are arranged on different sides of the main extension plane of the bow handle. Advantageously, an off-center shift of the center of gravity with respect to the main extension plane of the bow handle can be kept particularly low by the battery pack or the dust outlet and compensated for in a particularly advantageous manner. Advantageously, a grinding tool with a particularly high level of handling comfort can be provided. By way of example, the center of gravity of the grinding tool and the center of gravity of the battery pack are arranged on different sides of the main extension plane of the bow handle. The dust outlet is arranged in particular on the drive housing, preferably on the fan housing. The dust outlet is arranged in particular on one side of the separation plane, the main extension plane of the bow handle and/or the main extension plane of the handle housing. Preferably, the hand-held power tool system has a dust collection container, for example a dust box, a dust bag or the like. An overall center of gravity of the hand-held power tool system relates in particular to the hand-held power tool, preferably the grinding tool, with the battery pack and is preferably free of the dust collection container and/or the protective device. Preferably, the dust collection container can be attached to the dust outlet, in particular detachably, for example by means of a screw connection, a snap-in mechanism or the like. Alternatively, it is also conceivable that at least one dust outlet connecting piece of the dust collection container is formed in one piece with the dust outlet. Preferably, the dust collection container is rotatably mounted on the dust outlet. Alternatively, however, it is also conceivable that the dust collection container can be connected to the dust outlet in a rotationally fixed manner. In particular, the dust collection container is designed to collect dust and/or debris, preferably extracted by the extraction fan. Alternatively or additionally, it is conceivable that the dust outlet can be coupled to an active extraction device, for example a vacuum cleaner, in particular in the case of a hand-held power tool that is designed without an extraction fan. It is also conceivable that the dust collection container can be compressed by contact with the substrate when the hand-held power tool is parked in the parking and/or resting position, in particular to enable the hand-held power tool to be parked in the parking and/or resting position. Alternatively or additionally, it is also conceivable that the dust collection container is movable in the direction of the dust outlet, in particular movable relative to the dust outlet, by contact with the substrate when the hand-held power tool is parked in the parking and/or resting position.

It is also proposed that a ratio of a minimum distance between the center of gravity of the battery pack when arranged on the grinding tool and the drive axis of the drive unit to the maximum longitudinal extension of the tool holder is at least 0.85 and at most 1.2. Advantageously, a particularly favorable weight distribution can be achieved with regard to handling and/or guiding the hand-held power tool. A particularly high level of operating convenience can be achieved. The minimum distance between the center of gravity of the battery pack when arranged on the grinding tool and the drive axis runs in particular at least substantially parallel to the tool holder surface, the main extension plane of the bow handle, the main extension plane of the handle housing and/or the separation plane. The minimum distance between the center of gravity of the battery pack when arranged on the grinding tool and the drive axis is at least substantially perpendicular to the drive axis. By way of example, the minimum distance between the center of gravity of the battery pack and the drive axis is at least substantially 136 mm for a battery pack with 4 Ah electrical charge capacity, at least substantially 148 mm for a battery pack with 8 Ah electrical charge capacity and at least substantially 160 mm for a battery pack with 12 Ah electrical charge capacity. Alternatively, however, other values for the minimum distance between the center of gravity of the battery pack and the drive axis are also conceivable, in particular depending on the weight of the battery pack.

It is further proposed that an overall center of gravity of the hand-held power tool system, in particular that already mentioned above, is arranged in the handle recess of the bow handle. Advantageously, a particularly high level of comfort can be achieved when handling the hand tool. Advantageously, a particularly favorable weight distribution can be achieved. A minimum distance of the overall center of gravity from the separation plane of the handle housing, from the main extension plane of the handle housing and/or from the main extension plane of the bow handle is preferably smaller than the maximum transverse extension of the handle housing, in particular of the bow handle, starting from the separation plane of the handle housing, the main extension plane of the handle housing and/or the main extension plane of the bow handle. Preferably, the overall center of gravity is arranged in the separation plane of the handle housing, in the main extension plane of the handle housing and/or in the main extension plane of the bow handle. Preferably, the overall center of gravity of the hand-held power tool system is arranged at least with a battery pack with a single-layer battery cell arrangement within the handle recess of the bow handle. Preferably, a position of the overall center of gravity of the hand-held power tool system with a battery pack with a single-layer battery cell arrangement is such that the hand-held power tool can be set down on the tool holder, in particular without tilting. A minimum distance of the drive axis to the overall center of gravity has a value of at least 55 mm to at least 70 mm, in particular depending on the weight of the battery pack. The minimum distance between the drive axis and the overall center of gravity has a value of at most 65 mm to at most 75 mm, depending, in particular, on the weight of the battery pack. A maximum distance of the tool holder to the overall center of gravity in the direction of the drive axis has a value of at least 45 mm to at least 50 mm, depending, in particular, on the weight of the battery pack. The maximum distance between the tool holder and the overall center of gravity in the direction of the drive axis has a value of at most 52 mm to at most 55 mm, depending, in particular, on the weight of the battery pack.

It is further proposed that a ratio of the minimum distance between the center of gravity of the battery pack when arranged on the grinding tool and the drive axis of the drive unit to the maximum longitudinal extension of the handle recess of the bow handle is at least 2.0 and at most 3.0. Advantageously, a particularly precise and/or controlled handling of the grinding tool can be realized. Advantageously, particularly safe and/or precise working with the grinding tool can be achieved. Advantageously, a hand-held power tool system with particularly favorable ergonomic properties can be provided.

It is also proposed that the handle housing at least partially covers the central web on both sides in directions perpendicular to the main extension plane of the handle housing. Advantageously, a particularly large gripping surface can be provided for the operator. Contact between the operator and the drive housing when using the hand-held power tool apparatus can be counteracted. Advantageously, a particularly high level of operating comfort can be achieved. The handle housing covers the central web in the directions perpendicular to the main extension plane of the handle housing on both sides, in particular at a height of at least 10%, preferably at least 20% and preferably at least 30%. The central web is not covered by the handle housing, particularly in the longitudinal direction. It is also conceivable that the handle housing largely covers the central web at a height on both sides in the directions extending perpendicular to the main extension plane of the handle housing, in particular by at least 50%, preferably by at least 70% and preferably by at least 90%.

It is also proposed that an end of the handle housing facing the central web, preferably the end already mentioned above, in particular an end substantially surrounding the drive housing in a ring-like manner, is arranged at a distance from the drive housing, in particular at a radial and axial distance, preferably with respect to the drive axis. Advantageously, a particularly large grip area can be provided for the operator. Contact between the operator and the drive housing when using the hand-held power tool apparatus can be counteracted. Advantageously, a particularly high level of operating comfort can be achieved. Preferably, the end is arranged at a distance from the surface. Preferably, the end surrounds the motor housing of the drive housing like a ring. In particular, the motor housing is arranged on the central web. The motor housing is preferably arranged on a side of the central web facing away from the tool holder, in particular arranged above the central web with respect to the tool holder. The motor housing is preferably enclosed by the handle housing in a plane perpendicular to the drive axis. Preferably, the motor housing is at least substantially completely enclosed by the handle housing in a radial direction starting from the drive axis. By “at least substantially completely” can be understood at least 50%, preferably at least 75% and particularly preferably at least 90% of a total volume and/or a total mass of an object. Preferably, the motor housing is at least partially integral with the central web. The expression “at least one unit or one object and at least one further unit or object are at least partially designed to be integral with one another”, is in particular understood to mean that at least one element of the unit or of the object is designed to be integral with at least one further element of the further unit or with the further object. The term “integral” can be understood to mean at least a materially bonded connection, for example, by a welding process, a soldering process, an adhesive bonding process, an injection molding process and/or another process that appears to the person skilled in the art to be reasonable, and/or advantageously formed in one piece, for example, by production from a casting and/or by production in a single-component or multi-component injection molding process and advantageously from a single blank. The handle housing, in particular the end of the handle housing, is preferably arranged at a distance from the drive housing, in particular from the motor housing.

It is further proposed that the end of the handle housing facing the central web is adapted in shape to the drive housing, in particular the central web and/or the surface. Advantageously, a particularly large gripping surface for an operator can be realized with a particularly small space requirement at the same time. Preferably, the end has two recesses for the central web. It is conceivable that the end has a constant distance from the drive housing in the direction of the drive axis. Alternatively, however, it is also conceivable that the distance between the end and the drive housing varies in the direction of the drive axis.

It is also proposed that the central web has a holder for a user interface and/or a communication module. Advantageously, a particularly space-saving arrangement of a user interface can be achieved. Advantageously, a functionality of the hand-held power tool apparatus can be extended in a space-saving manner. Advantageously, a particularly protected and secure positioning of a user interface can be achieved. The receptacle is preferably designed as a recess in the central web. The user interface has, for example, one or more input elements. The input element of the user interface can, for example, be designed as a button, a rotary wheel, a switch or the like. By way of example, the hand-held power tool can be switched on and/or off via the user interface, in particular via the at least one input element of the user interface, and/or a rotational speed of the hand-held power tool, preferably of the grinding tool, can be adjusted or the like. It is conceivable that the user interface has one or more output element(s), for example a display, a light element, in particular an LED, or the like. By way of example, a rotational speed of the hand-held power tool, preferably the grinding tool, a state of charge of the battery pack, a device status of the hand-held power tool or the like can be output via the user interface, in particular via the at least one output element. Preferably, the user interface is connected by data technology to a control unit of the hand-held power tool, in particular the grinding tool, preferably by cable and/or wirelessly. The control unit is provided in particular for controlling the drive unit. The control unit comprises in particular at least one processor and one memory element, and an operating program stored in the memory element. The storage element is preferably designed as a digital storage medium, for example as a hard drive or the like. The receptacle is preferably arranged on a side of the motor housing facing away from the bow handle. In particular, the receptacle is arranged on a side of the handle housing facing away from the battery pack interface of the hand-held power tool. The communication module is configured in particular to communicate with another device, for example a smartphone, a laptop, a server, a cloud, a gateway or the like. Preferably, the communication module is connected to the control unit and/or the user interface using data technology, in particular wirelessly and/or by cable. It is conceivable that the communication module is part of the user interface. Alternatively, however, it is also conceivable that the communication module is designed and/or arranged separately from the user interface. By way of example, it is conceivable that the communication module is arranged in the handle housing, in particular in the bow handle. It is also conceivable that the communication module is part of the control unit. The communication module can have one or more data transmission technologies, for example Bluetooth, NFC or similar. The control unit is preferably arranged in the handle housing.

In one aspect of the disclosure, which can in particular be considered independently of further aspects of the disclosure, it is proposed that the drive housing has at least one air outlet opening which is at least partially covered by the handle housing, in particular when viewed at least in a main outlet direction of the air outlet opening. Advantageously, a particularly favorable exhaust air flow can be achieved. Advantageously, the operator can be protected from exhaust air in a particularly effective and/or structurally simple manner. Advantageously, a particularly high level of operating comfort can be achieved. Preferably, the air outlet opening is at least partially covered by the handle housing, at least when viewed in a plane perpendicular to the drive axis. It is conceivable that the handle housing covers at least most of the air outlet opening, preferably at least 50%, preferably at least 75% and particularly preferably at least 90%, especially when viewed in a plane perpendicular to the drive axis. It is also conceivable that the handle housing completely covers the air outlet opening, especially when viewed in a plane perpendicular to the drive axis. The main outlet direction is determined by an arrangement and/or geometry of the air outlet opening. By way of example, the main outlet direction runs at least substantially perpendicular to the drive axis and/or at an angle to the drive axis, preferably inclined in the direction of the tool holder. The air outlet opening is preferably covered by the end of the handle housing, in particular when viewed in a plane perpendicular to the drive axis. Preferably, the air outlet opening is arranged above the central web, preferably with respect to the tool holder and/or the surface.

Furthermore, it is proposed that the drive housing has a motor housing, in particular the motor housing already mentioned above, which is arranged on the central web and has the air outlet opening. The hot engine exhaust air can be effectively dissipated while at the same time providing particularly effective protection for the operator from the engine exhaust air. A hand-held power tool apparatus with a particularly high level of operating comfort can be provided. Preferably, the motor housing has a plurality of air outlet openings. The air outlet openings are spaced at a distance from one another in a peripheral direction, for example, which in particular runs in a plane perpendicular to the drive axis.

It is also proposed that an opening is formed between the end of the handle housing facing the central web and the drive housing to allow air to escape from the air outlet opening. The hot engine exhaust air can be effectively dissipated while at the same time providing particularly effective protection for the operator from the engine exhaust air. A hand-held power tool apparatus with a particularly high level of operating comfort can be provided. The opening is preferably arranged opposite the upper side. The opening is formed in particular by the spaced arrangement of the end of the handle housing relative to the drive housing, preferably the motor housing.

In one aspect of the disclosure, which can in particular be considered independently of further aspects of the disclosure, it is proposed that the drive housing has a closed cable duct. Advantageously, effective protection for a cable connection can be provided. Advantageously, a particularly space-saving and/or protected arrangement of a cable connection can be realized. It is conceivable that at least a part, in particular a large part, preferably at least 50%, preferably at least 70%, of the cable channel is enclosed by the handle housing, in particular when viewed in a plane extending perpendicular to the drive axis. One open end of the cable duct is preferably arranged at the receptacle. A further open end of the cable duct is preferably arranged in an inner region of the handle housing. In particular, the cable duct runs from the receptacle into the inner region of the handle housing. By way of example, the cable duct runs over the entire motor housing, in particular in the direction of the drive axis. Preferably, the hand-held power tool, in particular the grinding tool, and/or the hand-held power tool apparatus has an electrical connecting unit. In particular, the electrical connecting unit has at least one electrical connection element, for example a cable. The electrical connecting unit, in particular the electrical connecting element, is preferably intended to connect the user interface to the control unit, in particular at least in terms of data technology and/or control technology. Preferably, the user interface can be supplied with electrical power via the electrical connecting unit, preferably via the at least one electrical connecting element and/or a further electrical connecting element of the electrical connecting unit. The electrical connecting unit, in particular the at least one electrical connecting element and/or the further electrical connecting element, is/are arranged in the cable duct. The receptacle preferably has at least one electrical connection for the user interface and/or the communication interface. At least the electrical connecting element and/or the further electrical connecting element is/are connected to the terminal.

It is also proposed that the drive housing has at least two housing shells, between which the cable duct is arranged. Advantageously, a cable connection can be installed particularly easily in the cable duct. Advantageously, a closed cable duct can be provided in a simple design and, in particular, with a particularly high level of convenience when installing a cable connection. In particular, the drive housing has a shell construction with the two housing shells as half shells. The two housing shells of the drive housing are preferably connected to each other in a drive housing separation plane of the drive housing. The drive housing separation plane preferably runs at least substantially parallel to the separation plane of the handle housing. It is conceivable that the drive housing separation plane corresponds to the separation plane of the handle housing. Alternatively, however, it is also conceivable that the drive housing separation plane runs at an angle to the separation plane. Preferably, the cable duct runs inside the outer walls of the housing shells, in particular inside at least one outer wall of one of the housing shells. Preferably, the cable duct connects to a contact surface of the outer walls of the two housing shells.

It is also proposed that one housing shell of the housing shells forms a groove for the cable duct and another housing shell of the housing shells forms a lid for the cable duct. Advantageously, a closed cable duct can be easily provided by design.

It is further proposed that the cable duct is arranged at least partially on, in particular in, the central web. Advantageously, a closed cable duct can be realized in a particularly space-saving manner. It is conceivable that at least part of the cable duct runs through the central web, for example at least 5%, 10% or 20% of the cable duct.

Furthermore, a hand-held power tool, in particular a hand-held power tool, in particular a hand-held grinding tool, preferably the aforementioned grinding tool, is proposed with the hand-held power tool apparatus. Advantageously, a hand-held power tool with a particularly low overall height can be provided. A hand-held power tool with particularly favorable handling properties, in particular a particularly large gripping surface for the operator, can be provided.

It is also proposed that the grinding tool has a tool holder, in particular the aforementioned tool holder, for accommodating a tool, in particular the aforementioned tool, wherein the tool holder and/or the tool are/is at a distance from the substrate in the at least one parking and/or resting position. Advantageously, excessive loading of the tool holder and/or the tool in the at least one parking and/or resting position of the grinding tool can be counteracted. Damage to the tool holder and/or the tool, in particular by the substrate, can be counteracted. It is possible to replace the tool easily. Advantageously, a particularly high level of operating comfort can be achieved, especially when replacing tools and/or during maintenance work or the like on the tool holder.

It is further proposed that the grinding tool can be set down in the at least one parking and/or resting position solely via the support surface. Advantageously, the occurrence of signs of wear due to contact between the grinding tool, in particular the housing unit, and the substrate can be counteracted. Advantageously, the grinding tool can be parked particularly gently. Preferably, the grinding tool is at a distance from the substrate in the at least one parking and/or resting position. In particular, in the at least one parking and/or resting position, the grinding tool is connected to the substrate via the battery pack and can preferably be parked on the substrate. In the at least one parking and/or resting position, only the support surface on the battery pack is in contact with the substrate.

It is further proposed that a main extension plane of the support surface runs at an angle other than 900 to a main extension plane of the tool holder surface of the grinding tool. Advantageously, a particularly favorable weight distribution can be achieved with regard to the parking of the grinding tool. Advantageously, a particularly safe parking of the grinding tool can be achieved. Due to such an inclination of the tool holder surface, the tool can be mounted and dismounted particularly conveniently in the parking and/or resting position of the grinding tool. Advantageously, a particularly high level of user comfort can be achieved. In particular, a main extension axis of the hand-held power tool, especially the grinding tool, runs at an angle other than 90° to the main extension plane of the support surface. It is conceivable that the tool holder surface runs at least substantially parallel to the main extension axis of the hand-held power tool, in particular the grinding tool. In particular, a handle axis of the handle housing runs at an angle other than 90° to the main extension plane of the support surface in the parking and/or resting position. The handle axis is defined in particular by the bow handle. The handle axis preferably runs in the separation plane and/or in the main extension plane of the handle housing, in particular in the main extension plane of the bow handle. The handle axis corresponds in particular to a main extension axis of a handle tube of the bow handle.

It is also proposed that the main extension plane of the tool holder surface and the main extension plane of the support surface include an angle which is greater than 80°. Advantageously, a particularly safe and space-saving parking of the grinding tool can be enabled. Preferably, the angle enclosed by the main extension plane of the tool holder surface and the main extension plane of the support surface has a value of less than 90° and greater than 80°. In particular, the tool holder, preferably the tool holder surface, is inclined in a direction away from the substrate in the parking and/or resting position. Particularly preferably, the angle enclosed by the main extension plane of the tool holder surface and the main extension plane of the support surface has a value of at least substantially 86°.

It is further proposed that a normal of the main extension plane of the support surface intersects the battery pack and a center of gravity of the grinding tool. Advantageously, the grinding tool can be set down in a particularly stable manner. Preferably, the normal of the main extension plane of the support surface intersects a geometric center of the support surface and/or the center of gravity of the battery pack, in particular at least a close range of the geometric center of the support surface and/or a close range of the center of gravity of the battery pack. A “close range” is to be understood here in particular as a range which has a maximum distance to a reference point which is preferably less than 7%, preferably less than 5%, of a maximum longitudinal extension of the battery pack.

It is also proposed that an edge of the rechargeable battery pack housing of the battery pack forms the support surface. Advantageously, the grinding tool can be placed on the substrate in a particularly stable manner. Preferably, an edge of the rechargeable battery pack housing facing away from the tool holder forms the support surface. Preferably, the support surface and a support point of the grinding tool span a support plane of a, in particular further, parking and/or resting position of the support unit.

It is also proposed that a main extension axis of the battery pack runs at least substantially perpendicular to the main extension axis of the grinding tool. Advantageously, the grinding tool can be placed on the substrate in a particularly stable manner. Preferably, the edge of the battery pack housing runs at least substantially perpendicular to the main extension axis of the hand-held power tool.

It is further proposed that the grinding tool has only one, in particular the previously mentioned, support point, which comes to lie in a, in particular the previously mentioned, support plane of a, preferably the previously mentioned, in particular further, parking and/or resting position of the support unit. Advantageously, wear of the grinding tool, in particular the housing unit, can be kept particularly low by contact with the substrate, in particular with a particularly high stability when the grinding tool is set down. The support point is preferably located on the handle housing or the drive housing. The support point is preferably located on a surface of the palm handle. The palm handle preferably has a round shape. The surface of the palm handle on which the support point is arranged is preferably curved. Alternatively, however, it is also conceivable that the surface of the palm handle on which the support point is arranged is flat. The support point of the grinding tool is preferably arranged on a side of the handle housing facing away from the tool holder. Alternatively, however, it is also conceivable that at least one support elevation is arranged on the palm handle, which comes to lie in the support plane of the at least one, in particular further, parking and/or resting position. The at least one support elevation is intended in particular to form a support line for depositing the hand-held power tool. The support elevation is designed, for example, as an elongated web, the main extension axis of which runs at least substantially perpendicular to the main extension axis of the hand-held power tool, to the separation plane, to the main extension plane of the bow handle and/or to the main extension plane of the handle housing. Furthermore, it is also conceivable that the palm handle has at least two support elevations which are mutually spaced, preferably in a direction perpendicular to the separation plane, and which are formed as humps or the like and which preferably come to rest in the support plane of the at least one, in particular further, parking and/or resting position. A design with at least one support elevation on the palm handle makes it conceivable to place the hand-held power tool without battery pack in an additional parking and/or resting position, in which the hand-held power tool can be parked on the substrate via the at least one support elevation on the palm handle and a further support point on the handle housing, in particular in an area of the battery pack interface. Additionally or alternatively, it is also conceivable that at least one support elevation is arranged on the handle housing, in particular in the area of the battery pack interface.

It is further proposed that the support unit is designed for parking and/or resting the grinding tool on the substrate in at least one further parking and/or resting position, in particular the aforementioned further parking and/or resting position, wherein the battery pack has a further support surface of the support unit for the further parking and/or resting position. Advantageously, a particularly high degree of flexibility can be realized when parking the grinding tool safely on a substrate. By way of example, the edge of the battery pack forms the additional support surface of the support unit for the additional parking and/or resting position. In the further parking and/or resting position, the tool holder surface preferably runs at least substantially parallel to a support plane of the further parking and/or resting position. In the further parking and/or resting position, the drive axis runs in particular at least substantially perpendicular to the support plane of the further parking and/or resting position. In the further parking and/or resting position, the further support surface and the support point of the grinding tool in particular come to lie in the support plane of the further parking and/or resting position. The hand-held power tool system is preferably in contact with the substrate in the further parking and/or resting position via the further support surface on the battery pack and the support point on the grinding tool.

It is further proposed that the screen unit is intended to block the light emission of at least one light source at least in the direction of an intended operator side. Advantageously, an operator can be prevented from being dazzled when working with the protective device. Particularly safe and/or comfortable working with the protective device can be made possible. The screen unit is intended in particular to block a light emission of the at least one light source in a direction facing away from the tool holder. The operator side corresponds in particular to a position of the operator with respect to the hand-held power tool, in particular the light source, which the operator assumes when working on a workpiece.

In one aspect of the disclosure, which can in particular be considered independently of further aspects of the disclosure, it is proposed that the protective device has a light source unit. Advantageously, a workpiece can be illuminated with particular precision during machining. Advantageously, the light source unit can be maintained and/or replaced particularly easily. A particularly high level of operating convenience can be achieved. The light source unit preferably has at least one, for example the light source already mentioned, or several light sources. The light source unit, in particular the at least one light source, is preferably arranged on the base element, the screen unit or the light guide unit.

In one aspect of the disclosure, which can in particular be considered independently of further aspects of the disclosure, it is proposed that the protective device has at least one energy source and/or at least one operating element for at least one, in particular the aforementioned, light source. Advantageously, the functionality of the protective device can be extended. Such embodiment design of the protective device enables particularly convenient operation. The energy source can, for example, be designed as a battery, a rechargeable battery or the like. The energy source is provided in particular for supplying energy to the light source, preferably the light source unit. Preferably, the energy source is connected to the light source, in particular the light source unit, at least in one operating state. Alternatively or additionally, however, it is also conceivable that the light source, preferably the light source unit, can be supplied with electrical power via the hand-held power tool, in particular the grinding tool, for example via an electrical plug connection between the protective device and the hand-held power tool. The at least one operating element of the protective device is preferably arranged on the base element. The at least one operating element of the protective device can, for example, be designed as a button, a rotary wheel, a switch or the like. The at least one operating element of the protective device can be used, for example, to switch the at least one light source on and/or off and/or to set an illumination parameter, such as a light color, an intensity or the like.

In one aspect of the disclosure, which can in particular be considered independently of further aspects of the disclosure, it is proposed that the protective device has a sensor unit for detecting an operation of the hand-held power tool, in particular for activating at least one light source, in particular the light source unit already mentioned above, preferably the light source unit, during operation of the hand-held power tool. Advantageously, activation of the at least one light source can be automated. Advantageously, a particularly high level of user comfort can be achieved. The sensor unit is preferably arranged on the base element, on the screen unit or on the light guide unit. The sensor unit preferably has at least one sensor element, for example a vibration sensor or the like, for detecting operation of the hand-held power tool. The sensor unit preferably has control electronics for processing the sensor signals. The control electronics are preferably connected to the at least one light source, in particular the light source unit, for control purposes. In particular, the control electronics are intended to switch on the light source when an operation of the hand-held power tool is detected. It is conceivable that the control electronics are part of the control unit of the hand-held power tool. Alternatively, however, it is also conceivable that the control electronics are designed separately from the control unit.

In one aspect of the disclosure, which can in particular be considered independently of further aspects of the disclosure, it is proposed that the protective device is formed at least partially from a thermoplastic elastomer, in particular has a protective layer consisting at least partially of a thermoplastic elastomer. Advantageously, a particularly high level of impact protection can be realized. A particularly long lasting protection device can be provided. Preferably, the base element of the protective device is at least partially formed from a thermoplastic elastomer. Preferably, at least one surface of the protective device facing away from the hand-held power tool, in particular the base element, is formed from a thermoplastic elastomer. The protective layer can be a sleeve placed over the base element, a layer glued to the base element or the like. Alternatively or additionally, it is also conceivable that the protective layer is clamped, screwed or the like onto the base element. Furthermore, it is also conceivable that the base element is overmolded by the protective layer, in particular that the protective layer is injection-molded onto the base element, for example in a two-component injection molding process.

In one aspect of the disclosure, which can in particular be considered independently of further aspects of the disclosure, it is proposed that the protective device has a fastening unit for detachable fastening to the hand-held power tool with at least two fixing rails running parallel to one another, which have at least two latching recesses. Advantageously, a robust attachment of the protective device to the hand-held power tool can be easily realized. The hand-held power tool, in particular the drive housing, preferably the fan housing, has in particular a protective fastening unit corresponding to the fastening unit. The protective fastening unit has, for example, at least one fixing rail. The fixing rail of the protective fastening unit is arranged between the fixing rails of the fastening unit, in particular when the protective device, in particular the base element, is arranged on the hand-held power tool. The fixing rails of the fastening unit and the fixing rail of the protective fastening unit are preferably provided for fixing in an axial direction relative to one another, preferably with respect to the drive axis. The protective fastening unit preferably has two latching elements, in particular latching hooks or the like. The latching elements are intended in particular to cooperate with the latching recesses of the fastening unit to fasten the protective device, in particular the base element, to the hand-held power tool. Alternatively, it is also conceivable that the design of the fastening unit and the protective fastening unit are interchanged.

One aspect of the disclosure, which can be considered independently of further aspects of the disclosure in particular, proposes that the protective device has an asymmetrical basic shape, in particular adapted to a dust outlet of the hand-held power tool, in particular the dust outlet already mentioned above. In particular, a shape of the base element along its longitudinal extension separates from a circular shape in at least one section, preferably in a region of the dust outlet.

Furthermore, a hand-held power tool system is proposed, in particular the hand-held power tool system already mentioned above, with a hand-held power tool, in particular the hand-held power tool already mentioned above, and the protective device. A particularly efficient and/or precise illumination of a workpiece to be processed by means of the hand-held power tool can be realized. Such a design of the protective device can prevent the operator from being dazzled. Advantageously, a particularly high level of operating comfort and/or a particularly high level of operating safety can be realized.

In addition, the disclosure is based on a method for producing a protective device, in particular the aforementioned protective device. It is proposed that the protective device be made at least partially from a thermoplastic elastomer. Advantageously, a particularly durable protective device can be provided. Advantageously, a particularly efficient impact protection can be realized. Preferably, the base element is at least partially made of a thermoplastic elastomer, for example in a single or multi-component injection molding process.

It is further proposed that the hand-held power tool apparatus has a tool holder, in particular the aforementioned tool holder, for accommodating a tool, in particular the aforementioned tool, in particular an abrading medium, wherein a maximum distance of the cantilever from the drive axis is greater than a maximum distance of the tool holder from the drive axis, in particular when viewed in the separation plane of the handle housing.

Advantageously, a particularly wide support of the drive housing on the handle housing can be achieved. Advantageously, a particularly high level of stability can be achieved when guiding the hand-held power tool, in particular the hand-held power tool apparatus. Advantageously, particularly precise working with the hand-held power tool apparatus can be achieved. Preferably, a maximum distance of the part of the damping unit on the cantilever to the drive axis is greater than the maximum distance of the tool holder to the drive axis, in particular when viewed in the separation plane of the handle housing.

It is further proposed that a ratio of a maximum transverse extension of the part of the damping unit to a minimum distance of the part of the damping unit from the handle axis of the handle housing is at least 0.9 and at most 1.05. Advantageously, torques around the handle axis can be supported particularly effectively. Advantageously, a particularly high level of stability can be achieved. Particularly precise work can be realized with the hand-held power tool apparatus. The maximum transverse extension of the part of the damping unit runs in particular at least substantially perpendicular to the main extension plane of the handle housing, preferably the main extension plane of the bow handle, and/or the separation plane. The maximum transverse extension of the part of the damping unit preferably runs at least substantially parallel to the tool holder surface. The minimum distance of the part of the damping unit from the handle axis is preferably measured parallel to the separation plane, in particular to the main extension plane of the bow handle, preferably the main extension plane of the handle housing. The maximum transverse extension of the part of the damping unit is preferably at least 40 mm, preferably at least 45 mm. The maximum transverse extension of the part of the damping unit is preferably at most 60 mm, preferably at most 50 mm. A ratio of the maximum transverse extension of the part of the damping unit to the maximum height of the grinding tool is preferably at least 0.35, preferably at least 0.4. The ratio of the maximum transverse extension of the part of the damping unit to the maximum height of the grinding tool is preferably at most 0.5, preferably at most 0.45. The minimum distance of the part of the damping unit from the handle axis is preferably at least 45 mm, preferably at least 50 mm. The minimum distance of the part of the damping unit from the handle axis is preferably at most 60 mm, preferably at most 55 mm. Alternatively, however, it is also conceivable that the minimum distance of the part of the damping unit from the handle axis is less than 45 mm or greater than 60 mm.

It is also proposed that a ratio of the maximum transverse extension of the part of the damping unit to a minimum distance of the part of the damping unit from the drive axis is at least 0.7, preferably at least 0.73 and at most 0.8, preferably at most 0.77. Tipping forces can be supported particularly effectively. A particularly stable hand-held power tool apparatus can be provided. The minimum distance of the part of the damping unit to the drive axis is preferably measured parallel to the separation plane, in particular to the main extension plane of the bow handle, preferably the main extension plane of the handle housing. The minimum distance of the part of the damping unit to the drive axis is preferably at least 55 mm, preferably at least 60 mm. The minimum distance between the part of the damping unit and the drive axis is preferably at most 70 mm, preferably at most 65 mm. Alternatively, however, it is also conceivable that the minimum distance between the part of the damping unit and the drive axis is less than 55 mm or greater than 70 mm.

Furthermore, it is proposed that a ratio of a maximum height of the housing unit to the minimum distance of the part of the damping unit on the cantilever from the handle axis of the handle housing is a maximum of 2.25. A particularly wide support of the drive housing on the handle housing can be realized. Advantageously, a particularly high level of stability can be achieved when handling the hand-held power tool, in particular the grinding tool. The maximum height of the housing unit preferably runs in the separation plane, in particular in the main extension plane of the handle housing, preferably in the main extension plane of the bow handle. The maximum height of the housing unit runs in particular parallel to the drive axis. The maximum height of the housing unit is preferably at least 90 mm, preferably at least 100 mm. The maximum height of the housing unit is preferably a maximum of 120 mm, preferably a maximum of 110 mm. Alternatively, however, it is also conceivable that the maximum height of the housing unit in the direction of the drive axis is less than 90 mm or greater than 120 mm. A ratio of a maximum extension of the damping unit, in particular a maximum distance of the damping elements, in the direction of the drive axis to the maximum height of the housing unit is preferably at least 0.8, preferably at least 0.85. A ratio of the maximum extension of the damping unit, in particular of a maximum distance of the damping elements, in the direction of the drive axis to the maximum height of the grinding tool is preferably at least 0.7, preferably at least 0.75. The maximum extension of the damping unit, in particular the maximum distance of the damping elements, in the direction of the drive axis is preferably at least 85 mm, preferably at least 90 mm. Alternatively, however, it is also conceivable that the maximum extension of the damping unit, in particular the maximum spacing of the damping elements, in the direction of the drive axis is less than 85 mm.

It is also proposed that a ratio of the minimum distance of the part of the damping unit from the drive axis in a direction perpendicular to the drive axis to a maximum longitudinal extension of the housing unit is greater than 0.3. A particularly wide support of the drive housing on the handle housing can be realized. Advantageously, a particularly high level of stability can be achieved when handling the hand-held power tool, in particular the grinding tool. The maximum longitudinal extension of the housing unit preferably runs perpendicular to the drive axis. The maximum longitudinal extension of the housing unit preferably runs at least substantially parallel to the tool holder surface. The maximum longitudinal extension of the housing unit runs in particular in the separation plane, preferably in the main extension plane of the handle housing, in particular in the main extension plane of the bow handle. The maximum longitudinal extension of the housing unit is preferably at least 175 mm, preferably at least 180 mm. The maximum longitudinal extension of the housing unit is preferably at most 190 mm, preferably at most 185 mm. Alternatively, however, it is also conceivable that the maximum longitudinal extension of the housing unit is less than 175 mm or greater than 190 mm.

It is further proposed that a ratio of the minimum distance between the part of the damping unit and the drive axis to the minimum distance between the part of the damping unit and the handle axis of the handle housing is at least 1.2 and at most 1.3. A hand-held power tool apparatus with a particularly favorable support of the drive housing on the handle housing can be provided.

It is further proposed that the handle housing has a bow handle, in particular the aforementioned bow handle, which is supported on the drive housing via the part of the damping unit and/or the cantilever to form the closed handle recess of the bow handle. Advantageously, a particularly effective support of the drive housing on the handle housing can be achieved with simultaneous vibration decoupling of the handle housing from the drive housing. A particularly high level of handling stability can be achieved with a particularly high level of operating comfort at the same time.

It is also proposed that the part of the damping unit and/or the cantilever in the direction of the handle axis is arranged at the level of the handle recess. A particularly wide support of the drive housing on the handle housing can be achieved. Advantageously, a hand-held power tool apparatus can be provided with a particularly high stability and at the same time particularly effective vibration decoupling. Preferably, the part of the damping unit on the cantilever and/or the cantilever, viewed in the direction of the handle axis, is arranged at least substantially completely within the maximum longitudinal extension of the handle recess.

Furthermore, it is proposed that the part of the damping unit arranged on the cantilever has at least two damping elements arranged mutually spaced. Advantageously, a particularly favorable ratio between stable support of the drive housing on the handle housing and vibration decoupling of the handle housing from the drive housing can be achieved. The damping elements are preferably arranged on opposite sides of the cantilever. Preferably, the damping elements are arranged on different sides of the separation plane, in particular the main extension plane of the handle housing, preferably the main extension plane of the bow handle. Preferably, the damping elements are arranged symmetrically identical relative to the separation plane, in particular the main extension plane of the handle housing, preferably the main extension plane of the bow handle. The cantilever preferably has two damping element holders for the two damping elements or the aforementioned damping element holder is configured to accommodate the two damping elements.

It is also proposed that the housing unit has a fan housing, in particular the aforementioned fan housing, for accommodating an extraction fan, in particular the aforementioned extraction fan, wherein the cantilever is arranged on the fan housing. Advantageously, a particularly wide support of the drive housing can be realized. Particularly stable guidance of the hand-held power tool, in particular the hand-held power tool apparatus, can be achieved with simultaneous vibration decoupling of the drive housing from the handle housing. The extraction fan is in particular part of the hand-held power tool, preferably the grinding tool. Alternatively, it is also conceivable that the hand-held power tool, in particular the grinding tool, is designed without an extraction fan. Preferably, the cantilever is at least partially integral with the fan housing. In particular, the cantilever is arranged on a side of the fan housing facing the battery pack interface. It is conceivable that the cantilever is preferably arranged between two oscillating legs of the tool holder in a hand-held power tool designed as an orbital sander, which has a rectangular tool holder, for example. The oscillating legs are made in particular from an elastic material, preferably from a plastic. The oscillating legs are preferably connected to the drive housing, in particular to the fan housing.

In one aspect of the disclosure, which can in particular be considered independently of further aspects of the disclosure, it is proposed that the drive housing has a motor housing, in particular the aforementioned motor housing, for accommodating the drive unit and a fan housing, in particular the aforementioned fan housing, for accommodating an extraction fan, in particular the aforementioned extraction fan, wherein the motor housing and the fan housing are at least partially formed integrally with one another. Advantageously, a tolerance chain can be kept particularly low. A particularly high stability of the drive housing can be achieved. The fan housing and the motor housing have common housing shells, in particular the aforementioned housing shells of the drive housing. The two housing shells each have one half of the fan housing and one half of the motor housing.

In one aspect of the disclosure, which can in particular be considered independently of further aspects of the disclosure, it is proposed that the drive housing has a motor housing, in particular the motor housing already mentioned above, on which at least one damping element of the damping unit is arranged such that the damping element is only partially enclosed by the handle housing when viewed in a sectional plane perpendicular to the drive axis through the damping element. Advantageously, the handle housing can be supported on the drive housing at a point on the handle housing that is particularly far outwards in the axial direction, in particular in relation to the drive axis. A particularly efficient support can be provided with simultaneous vibration decoupling. A particularly high level of stability can be achieved when handling the hand-held power tool, in particular the grinding tool. Preferably, the sectional plane through the damping element only intersects part of the end of the handle housing facing the central web, in particular due to the two recesses in the end for the central web.

In one aspect of the disclosure, which can in particular be considered independently of further aspects of the disclosure, it is proposed that the damping unit has at least one sealing element, in particular a sealing ring, in order to block an inlet of exhaust air into the housing unit, in particular into the handle housing, wherein the sealing element, in particular the sealing ring, is arranged between the handle housing and the drive housing. Advantageously, an inflow of warm motor air into the handle housing can be counteracted. Overheating of the hand-held power tool, in particular the grinding tool, can be counteracted. It is conceivable that the sealing element is arranged, in particular designed, as a closed sealing ring. The sealing element surrounds the motor housing in a peripheral direction, which in particular runs in a plane perpendicular to the drive axis, preferably at least substantially completely, in particular in an angular range of at least 270°, preferably at least 330°, preferably at least 350° and particularly preferably completely. The sealing element preferably fills a gap between the motor housing and the handle housing at least substantially completely. The sealing element is preferably made of an elastic material, preferably an elastic plastic. The sealing element preferably has a material hardness that differs from that of the damping elements. The material hardness of the sealing element is preferably lower than the material hardness of the damping elements. Alternatively, it is conceivable that the sealing element and the damping elements have an identical material hardness. The sealing element is arranged above at least one air outlet in relation to the tool holder.

The hand-held power tool, in particular the grinding tool, the hand-held power tool system, the protective device, the method and/or the hand-held power tool apparatus should not be limited to the application and embodiment described above. In particular, the hand-held power tool, in particular the grinding tool, the hand-held power tool system, the method and/or the hand-held power tool apparatus can/can have a number of individual elements, components and units as well as method steps that deviates from a number specified herein in order to fulfill a mode of operation described herein. Moreover, regarding the ranges of values indicated in this disclosure, values lying within the limits specified hereinabove are also intended to be considered as disclosed and usable as desired.

### BRIEF DESCRIPTION OF THE DRAWINGS

Further advantages will emerge from the following description of the drawings. Two embodiment examples of the disclosure are shown in the drawing. The drawings, the description, and the disclosure contain numerous features in combination. The person skilled in the art will appropriately also consider the features individually and combine them into additional advantageous combinations.

Shown are:

FIG. 1 a hand-held power tool system with a hand-held power tool in a side view,

FIG. 2 the hand-held power tool system in a plan view,

FIG. 3 the hand-held power tool system in a front view,

FIG. 4 the hand-held power tool system in a side view with a handle housing shell,

FIG. 5 the hand-held power tool system in a cross-sectional view in a separation plane of a handle housing of the hand-held power tool,

FIG. 6 a plan view of the hand-held power tool in a cross-sectional view,

FIG. 7 the hand-held power tool system in a parking and/or resting position on a substrate,

FIG. 8 the hand-held power tool system in a further parking and/or resting position placed on the substrate,

FIG. 9a a base element of a protective device of the hand-held power tool system in a perspective view,

FIG. 9b the base element of the protective device in a plan view,

FIG. 10a a section of a drive housing of the hand-held power tool in a perspective view,

FIG. 10b the drive housing in a plan view,

FIG. 11 a schematic sequence of a method for producing a hand-held power tool apparatus for the hand-held power tool machine and

FIG. 12 a hand-held power tool system with a hand-held power tool machine in an alternative design.

### DETAILED DESCRIPTION

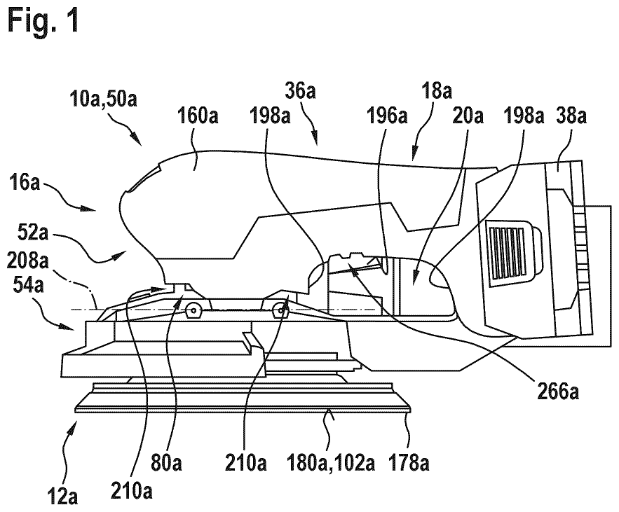

FIG. 1 shows a hand-held power tool system 36a with a hand-held power tool 50a, in particular a hand-held grinding tool. The hand-held power tool 50a is designed as a grinding tool 10a, in particular as a battery-powered grinding tool. Alternatively, however, it is also conceivable that the hand-held power tool 50a, in particular the grinding tool 10a, is designed as a mains-powered hand-held power tool. The grinding tool 10a is designed as a random orbital sander. Alternatively, however, it is also conceivable that the grinding tool 10a is designed as an orbital sander, a delta sander, a mini-random orbital sander or the like.

The hand-held power tool 50a has a tool holder 12a for accommodating a tool 178a. The tool holder 12a is designed as a sanding pad. The tool holder 12a is designed as a round sanding pad. Alternatively, however, it is also conceivable that the tool holder 12a is designed as a delta pad, as a square, preferably rectangular, sanding pad or as another sanding pad that appears useful to a person skilled in the art.

The tool holder 12a has fastening means for fastening the tool 178a. The tool holder 12a preferably has a hook-and-loop surface 180a for fastening the tool 178a. Alternatively or additionally, it is conceivable that the fastening means comprise several hook-and-loop surface, one or more clamps, a combination of these or other fastening means that would appear useful to a person skilled in the art. The tool 178a is designed as an abrading medium, for example as an sandpaper, as an abrasive fleece, as an abrasive grid or the like.

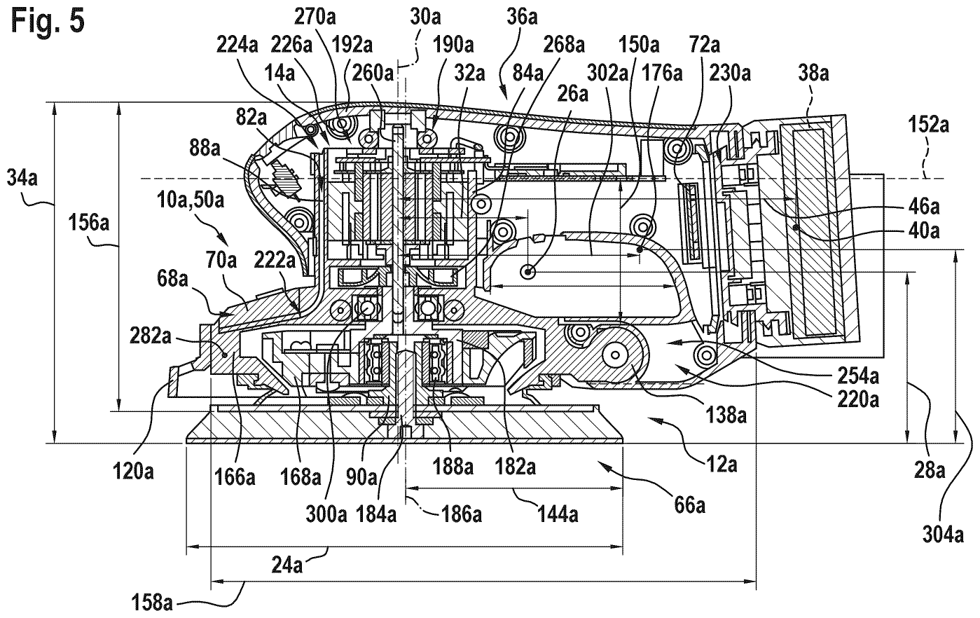

The hand-held power tool 50a has a drive unit 14a for driving the tool holder 12a. The drive unit 14a has a drive element 182a, preferably an eccentric (see FIG. 5). The drive element 182a is provided for actuation about a drive axis 30a of the drive unit 14a. The hand-held power tool 50a has an output unit 66a. The tool holder 12a is part of the output unit 66a. The output unit 66a has a connecting piece 90a. The connecting piece 90a is arranged, preferably fixed, on the drive element 182a. The tool holder 12a is fastened to the connecting piece 90a, in particular in a rotationally fixed manner, for example by means of a screw 184a or the like.

The output unit 66a has an output axis 186a. The output axis 186a preferably runs at least substantially parallel to the drive axis 30a. The drive axis 30a is spaced at a distance from the output axis 186a. The connecting piece 90a and/or the tool holder 12a, in particular the output axis 186a, moves in at least one operating state about the drive axis 30a, preferably in a circular manner. The drive element 182a is provided for actuating the connecting piece 90a and/or the tool holder 12a, in particular the output axis 186a, to move, preferably circularly, about the drive axis 30a of the drive element 182a.

The connecting piece 90a is rotatably attached to the drive element 182a, in particular rotatably about the output axis 186a. The hand-held power tool 50a has at least one bearing element 188a. The connecting piece 90a is mounted on the drive element 182a rotatably, in particular rotatably about the output axis 186a, via the bearing element 188a. The bearing element 188a is preferably arranged between the drive element 182a and the connecting piece 90a. The bearing element 188a can be designed as a radial bearing, in particular as a rolling bearing, for example as a ball bearing, or as a plain bearing.

The drive unit 14a is provided for actuating the output unit 66a, in particular the tool holder 12a. The drive unit 14a has an electric motor 190a, in particular for driving the drive element 182a.

The hand-held power tool 50a, in particular the grinding tool 10a, has at least one further bearing element 300a. The drive element 182a is mounted rotatably, in particular rotatably about the drive axis 30a, on a drive housing 54a of the hand-held power tool 50a via the further bearing element 300a. The further bearing element 300a can be designed as a radial bearing, in particular as a rolling bearing, for example as a ball bearing, or as a plain bearing.

The hand-held power tool 50, in particular the grinding tool 10a, has a housing unit 16a. The housing unit 16a has a drive housing 54a for accommodating the drive unit 14a. The drive housing 54a is designed as a plastic housing. Alternatively, however, it is also conceivable that the drive housing 54a is at least partially designed as a metal housing, for example as an aluminum housing or the like.

The housing unit 16a has a handle housing 52a. The handle housing 52a is designed as a plastic housing. Alternatively, however, it is also conceivable that the handle housing 52a is at least partially formed as a metal housing, for example as an aluminum housing or the like. The handle housing 52a has two handle housing shells 192a, 194a, which are interconnected in particular in a separation plane 146a of the handle housing 52a. The handle housing 52a is formed separately from the drive housing 54a, in particular arranged at a distance from the drive housing 54a. In particular, the handle housing 52a has a shell construction with the two handle housing shells 192a, 194a as half shells.

The housing unit 16a has a bow handle 18a. The bow handle 18a is a part of the handle housing 52a. The bow handle 18a has a finger grip surface 196a. The bow handle 18a has two walls 198a, in particular lateral walls, which delimit the finger grip surface 196a, in particular viewed in a main extension plane 42a of the bow handle 18a and in a direction perpendicular to the drive axis 30a. The bow handle 18a is designed as a closed bow handle. Alternatively, however, it is also conceivable that the bow handle 18a is designed as an open bow handle. The walls 198a define, in particular delimit, a handle recess 20a of the bow handle 18a at least partially.

A maximum longitudinal extension 22a of the handle recess 20a runs at least substantially parallel to a tool holder surface 102a of the tool holder 12a. The maximum longitudinal extension 22a of the handle recess 20a runs in a main extension plane 64a of the handle housing 52a, preferably in the main extension plane 42a of the bow handle 18a, in particular in the separation plane 146a of the handle housing 52a. The tool holder surface 102a runs at least substantially perpendicular to the separation plane 146a, the main extension plane 64a of the handle housing 52a and/or the main extension plane 42a of the bow handle 18a.

Here, the main extension plane 42a of the bow handle 18a is congruent with the main extension plane 64a of the handle housing 52a. Alternatively, it is conceivable that the main extension plane 42a of the bow handle 18a is different from the main extension plane 64a of the handle housing 52a. In this case, the separation plane 146a is congruent with the main extension plane 64a of the handle housing 52a, in particular the main extension plane 42a of the bow handle 18a. Alternatively, however, it is also conceivable that the main extension plane 42a of the bow handle 18a and/or the main extension plane 64a of the handle housing 52a are/is different from the separation plane 146a.

A ratio of the maximum longitudinal extension 22a of the handle recess 20a of the bow handle 18a to a maximum longitudinal extension 24a of the tool holder 12a is at least 0.35, preferably at least 0.38. The ratio of the maximum longitudinal extension 22a of the handle recess 20a of the bow handle 18a to a maximum longitudinal extension 24a of the tool holder 12a is at most 0.5, preferably at most 0.45 and preferably at most 0.42. Particularly preferably, the ratio of the maximum longitudinal extension 22a of the handle recess 20a of the bow handle 18a to the maximum longitudinal extension 24a of the tool holder 12a is at least substantially 0.4.

The maximum longitudinal extension 22a of the handle recess 20a is at least 50 mm, preferably at least 55 mm and particularly preferably at least 60 mm. The maximum longitudinal extension 22a of the handle recess 20a is at most 80 mm, preferably at most 70 mm and particularly preferably at most 75 mm. The maximum longitudinal extension 22a of the handle recess 20a is here exemplarily at least substantially 61 mm. Alternatively, however, it is also conceivable that the maximum longitudinal extension 22a of the handle recess 20a is greater than 80 mm or less than 50 mm.

The maximum longitudinal extension 24a of the tool holder 12a corresponds here in particular to a maximum diameter of the tool holder surface 102a. In this example, the maximum longitudinal extension 24a is 150 mm, in particular between 148 mm and 152 mm. Alternatively, however, it is also conceivable that the maximum longitudinal extension 24a of the tool holder 12a, in particular the maximum diameter of the tool holder surface 102a, is greater than 150 mm, in particular greater than 152 mm, or is less than 150 mm, in particular less than 148 mm.

A maximum diameter of the tool 178a is greater than the maximum longitudinal extension 24a of the tool holder 12a. Alternatively, however, it is also conceivable that the maximum diameter of the tool 178a is equal to or smaller than the maximum longitudinal extension 24a of the tool holder 12a.

The maximum longitudinal extension 24a of the tool holder 12a runs at least substantially parallel to the maximum longitudinal extension 22a of the handle recess 20a and/or the tool holder surface 102a. The maximum longitudinal extension 24a of the tool holder 12a runs in the separation plane 146a of the handle housing 52a, the main extension plane 64a of the handle housing 52a and/or in the main extension plane 42a of the bow handle 18a. The maximum longitudinal extension 24a of the tool holder 12a is defined by a maximum longitudinal extension of the tool holder surface 102a. The tool 178a is intended to be arranged on the tool holder surface 102a. The hook and loop surface 180a corresponds to the tool holder surface 102a.

The handle housing 52a has a palm handle 160a, in particular a handle knob. The palm handle 160a is arranged such that the drive axis 30a intersects the palm handle 160a. The bow handle 18a merges in particular into the palm handle 160a, preferably adjoins the palm handle 160a.

The hand-held power tool 50a has an extraction fan 168a. The extraction fan 168a is intended for extracting the material removed from the workpiece during machining of a workpiece and, in particular, for blowing it out of a dust outlet 44a.

A fan housing 166a of the housing unit 16a, in particular of the drive housing 54a, for accommodating the extraction fan 168a is arranged between the tool holder 12a and the palm handle 160a. The handle housing 52a, in particular the palm handle 160a, surround a motor housing 78a of the drive housing 54a, preferably at least in a plane extending perpendicular to the drive axis 30a.

The grinding tool 10a has a battery pack interface 218a for electrical and/or mechanical connection to a battery pack 38a. The battery pack interface 218a has guide means, for example one or more guide rails or the like, for guiding the battery pack 38a during assembly and/or disassembly of the battery pack 38a to and/or from the battery pack interface 218a. The battery pack interface 218a, in particular the guide means, provides/provides an insertion direction for the battery pack 38a when the battery pack 38a is mounted on the battery pack interface 218a. The insertion direction preferably runs at least substantially perpendicular to the drive axis 30a, to the separation plane 146a, to the main extension plane 42a of the bow handle 18a and/or to the main extension plane 64a of the handle housing 52a. The insertion direction runs at least substantially parallel to the tool holder surface 102a.

The battery pack interface 218a is arranged on the handle housing 52a, in particular on a side of the bow handle 18a facing away from the palm handle 160a. The battery pack interface 218a is free from an interface with the drive axis 30a and/or with a main extension plane 232a of the tool holder surface 102a.

The hand-held power tool 50a has at least one input element 162a. By actuating the input element 162a by the operator, the hand-held power tool 50a can be switched on and/or off. Alternatively or additionally, it is conceivable that a rotational speed of the hand-held power tool 50a or the like can be set by means of the input element 162a. The input element 162a can, for example, be designed as a button, a rotary wheel, a switch or the like. The input element 162a is arranged on the palm handle 160a, preferably on a side of the palm handle 160a facing away from the battery pack interface 218a, the tool holder 12a and/or the bow handle 18a.

The grinding tool 10a is intended to be guided with one hand, in particular by means of the bow handle 18a and the palm handle 160a. Alternatively, however, it is also conceivable that the grinding tool 10a is designed as a two-handed guide, wherein in each case one hand of the operator is arranged on the palm handle 160a and on the bow handle 18a.

A center of gravity 26a of the hand-held power tool 50a is arranged in the handle recess 20a. The center of gravity 26a is arranged within the handle recess 20a, as viewed in at least one direction extending perpendicularly to the main extension plane 42a of the bow handle 18a, in particular to the main extension plane 64a of the handle housing 52a.

A minimum distance (not shown here) of the center of gravity 26a from the separation plane 146a of the handle housing 52a, from the main extension plane 64a of the handle housing 52a and/or from the main extension plane 42a of the bow handle 18a is smaller than a maximum transverse extension 200a of the handle housing 52a starting from the separation plane 146a of the handle housing 52a, the main extension plane 64a of the handle housing 52a or the main extension plane 42a of the bow handle 18a. It is also conceivable that the center of gravity 26a is arranged in the separation plane 146a of the handle housing 52a, in the main extension plane 64a of the handle housing 52a and/or in the main extension plane 42a of the bow handle 18a.

The maximum transverse extension 200a of the handle housing 52a, in particular of the bow handle 18a, in particular starting from the separation plane 146a of the handle housing 52a, the main extension plane 64a of the handle housing 52a and/or the main extension plane 42a of the bow handle 18a, runs at least substantially perpendicular to the main extension plane 42a of the bow handle 18a, in particular to the main extension plane 64a of the handle housing 52a, to the separation plane 146a and/or to the drive axis 30a. The maximum transverse extension 200a of the handle housing 52a, in particular of the bow handle 18a, in particular starting from the separation plane 146a of the handle housing 52a, the main extension plane 64a of the handle housing 52a and/or the main extension plane 42a of the bow handle 18a, runs at least substantially parallel to the tool holder surface 102a.

A ratio of a maximum distance 28a of the tool holder 12a from the center of gravity 26a in the direction of the drive axis 30a of the drive unit 14a to a minimum distance 32a between the drive axis 30a and the center of gravity 26a is at least 2.8, preferably at least 3.0, more preferably at least 3.1. The ratio of a maximum distance 28a of the tool holder 12a from the center of gravity 26a in the direction of the drive axis 30a of the drive unit 14a to a minimum distance 32a between the drive axis 30a and the center of gravity 26a is at most 3.5, preferably at most 3.2.

The maximum distance 28a of the tool holder 12a from the center of gravity 26a in the direction of the drive axis 30a is at least 30 mm, preferably at least 33 mm, preferably at least 35 mm. The maximum distance 28a of the tool holder 12a from the center of gravity 26a in the direction of the drive axis 30a is in particular at most 50 mm, preferably at most 45 mm and particularly preferably at most 40 mm. As an example, the maximum distance 28a of the tool holder 12a from the center of gravity 26a in the direction of the drive axis 30a is here at least substantially 38 mm. Alternatively, however, it is also conceivable that the maximum distance 28a of the tool holder 12a from the center of gravity 26a in the direction of the drive axis 30a is less than 30 mm or greater than 50 mm.

The minimum distance 32a of the drive axis 30a from the center of gravity 26a is in particular at least 8 mm, preferably at least 10 mm. The minimum distance 32a of the drive axis 30a from the center of gravity 26a is in particular at most 20 mm, preferably at most 15 mm. As an example, the minimum distance 32a of the drive axis 30a from the center of gravity 26a is at least substantially 38 mm. Alternatively, however, it is also conceivable that the minimum distance 32a of the drive axis 30a to the center of gravity 26a is less than 8 mm or greater than 20 mm.

The maximum distance 28a of the tool holder 12a from the center of gravity 26a in the direction of the drive axis 30a is defined by a distance of the tool holder surface 102a from the center of gravity 26a in the direction of the drive axis 30a.

The drive axis 30a runs at least substantially perpendicular to the tool holder surface 102a. The drive axis 30a runs at least substantially parallel to the main extension plane 64a of the handle housing 52a, in particular to the main extension plane 42a of the bow handle 18a, and/or to the separation plane 146a. The drive axis 30a runs in the main extension plane 64a of the handle housing 52a, in the main extension plane 42a of the bow handle 18a and/or in the separation plane 146a.

The minimum distance 32a between the drive axis 30a and the center of gravity 26a runs at least substantially perpendicular to the drive axis 30a. The minimum distance 32a between the drive axis 30a and the center of gravity 26a runs at least substantially parallel to the tool holder surface 102a, to the main extension plane 64a of the handle housing 52a, to the main extension plane 42a of the bow handle 18a and/or to the separation plane 146a.

A maximum height 34a of the hand-held power tool 50a, in particular of the grinding tool 10a, has a ratio of at least 2.8, preferably at least 3.0, in the direction of the drive axis 30a to the maximum distance 28a between the tool holder 12a and the center of gravity 26a in the direction of the drive axis 30a. The ratio of the maximum height 34a of the grinding tool 10a in the direction of the drive axis 30a to the maximum distance 28a between the tool holder 12a and the center of gravity 26a in the direction of the drive axis 30a is at most 3.2, preferably at most 3.1.

The maximum height 34a of the grinding tool 10a is here exemplarily at least 100 mm, preferably at least 110 mm. The maximum height 34a of the grinding tool 10a is here exemplarily a maximum of 130 mm, preferably a maximum of 120 mm. Alternatively, however, it is also conceivable that the maximum height 34a of the grinding tool 10a in the direction of the drive axis 30a is less than 110 mm or greater than 130 mm. The maximum height 34a of the grinding tool 10a in the direction of the drive axis 30a runs from the tool holder surface 102a parallel to the drive axis 30a to an outermost point of the handle housing 52a.

A ratio of the maximum height 34a of the grinding tool 10a to a maximum height 202a of the handle recess 20a in a direction parallel to the drive axis 30a is at least 4.0, preferably at least 4.3, particularly preferably at least 4.4. The ratio of the maximum height 34a of the grinding tool 10a to the maximum height 202a of the handle recess 20a in a direction parallel to the drive axis 30a is at most 5.0, preferably at most 4.7, particularly preferably at most 4.6. The maximum height 34a of the handle recess 20a is here exemplarily between 20 mm and 30 mm, preferably between 24 mm and 28 mm and particularly preferably at least substantially 26 mm.

The handle recess 20a is closed, preferably substantially closed in an oval shape. The handle recess 20a is closed when viewed in the main extension plane 42a of the bow handle 18a, in the main extension plane 64a of the handle housing 52a and/or in the separation plane 146a. The handle recess 20a is closed by walls of the drive housing 54a, in particular the fan housing 166a of the drive housing 54a, and the handle housing 52a. Alternatively, it is conceivable that the handle recess 20a is completely closed by walls of the handle housing 52a.

The handle recess 20a has an oval shape, in particular when viewed in a direction perpendicular to the main extension plane 42a of the bow handle 18a, preferably to the main extension plane 64a of the handle housing 52a. Alternatively, however, it is also conceivable that the handle recess 20a has a rectangular shape, a square shape, a circular shape, or another shape that would appear useful to a person skilled in the art, in particular when viewed in the direction perpendicular to the main extension plane 42a of the bow handle 18a, preferably to the main extension plane 64a of the handle housing 52a.

The hand-held power tool system 36a has the battery pack 38a for supplying power to the hand-held power tool 50a. The battery pack 38a has a center of gravity of the battery pack 40a. The center of gravity of the battery pack 40a is offset from the main extension plane 42a of the bow handle 18a when arranged on the grinding tool 10a.

A minimum distance (not shown here) of the center of gravity of the battery pack 40a from the separation plane 146a of the handle housing 52a, from the main extension plane 64a of the handle housing 52a and/or from the main extension plane 42a of the bow handle 18a is smaller than the maximum transverse extension 200a of the handle housing 52a, in particular of the bow handle 18a, starting from the separation plane 146a of the handle housing 52a, the main extension plane 64a of the handle housing 52a or the main extension plane 42a of the bow handle 18a.

The minimum distance of the center of gravity of the battery pack 40a from the separation plane 146a of the handle housing 52a, from the main extension plane 64a of the handle housing 52a and/or from the main extension plane 42a of the bow handle 18a is in particular less than 20 mm, preferably less than 15 mm and preferably less than 10 mm. The minimum distance of the center of gravity of the battery pack 40a from the separation plane 146a of the handle housing 52a, from the main extension plane 64a of the handle housing 52a and/or from the main extension plane 42a of the bow handle 18a is here exemplarily at least substantially 8 mm.

The hand-held power tool system 36a has a dust outlet 44a. The dust outlet 44a is arranged on the drive housing 54a, in particular on the fan housing 166a. The center of gravity of the battery pack 40a and the dust outlet 44a are arranged on different sides of the main extension plane 42a of the bow handle 18a. The center of gravity 26a of the grinding tool 10a and the center of gravity of the battery pack 40a are disposed on different sides of the main extension plane 42a of the bow handle 18a.

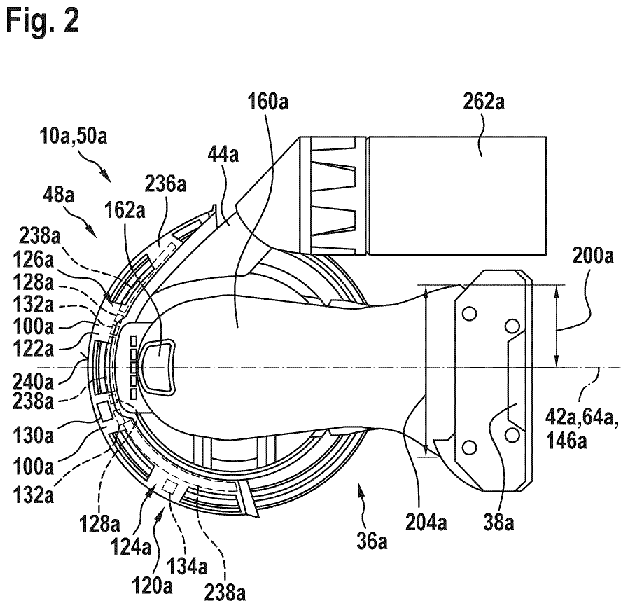

The hand-held power tool system 36a includes a dust collection container 262a, such as a dust box, dust bag or the like (see FIG. 2). The dust collection container 262a can be attached, in particular detachably, to the dust outlet 44a, for example by means of a screw connection, a snap-in mechanism or the like. Alternatively, it is also conceivable that at least one dust outlet connecting piece of the dust collection container 262a is formed integrally with the dust outlet 44a.

The dust collection container 262a is rotatably mounted on the dust outlet 44a. Alternatively, however, it is also conceivable that the dust collection container 262a can be connected to the dust outlet 44a in a rotationally fixed manner. The dust collection container 262a is provided for collecting dust and/or material removed by suction, preferably by means of the extraction fan 168a.

Alternatively or additionally, it is conceivable that the dust outlet 44a can be coupled to an active extraction device (not shown here), for example a vacuum cleaner or the like, in particular in the case of a hand-held power tool 50a which is formed free of an extraction fan 168a. The dust outlet 44a is arranged on one side of the separation plane 146a, the main extension plane 42a of the bow handle 18a and/or the main extension plane 64a of the handle housing 52a.

A ratio of a minimum distance 46a between the center of gravity of the battery pack 40a, when arranged on the grinding tool 10a, and the drive axis 30a to the maximum longitudinal extension 24a of the tool holder 12a is at least 0.85 and at most 1.2.

The minimum distance 46a between the center of gravity of the battery pack 40a, when arranged on the grinding tool, 10a and the drive axis 30a runs at least substantially parallel to the tool holder surface 102a, the main extension plane 42a of the bow handle 18a, the main extension plane 64a of the handle housing 52a and/or the separation plane 146a. The minimum distance 46a between the center of gravity of the battery pack 40a, when arranged on the grinding tool 10a, and the drive axis 30a runs at least substantially perpendicular to the drive axis 30a.

By way of example, the minimum distance 46a between the center of gravity of the battery pack 40a and the drive axis 30a is at least substantially 136 mm for a battery pack 38a with 4 Ah electrical charge capacity, at least substantially 148 mm for a battery pack 38a with 8 Ah electrical charge capacity and at least substantially 160 mm for a battery pack 38a with 12 Ah electrical charge capacity.

The ratio of the minimum distance 46a between the center of gravity of the battery pack 40a, when arranged on the grinding tool 10a, and the drive axis 30a to the maximum longitudinal extension 24a of the tool holder 24a is at least 0.85 and at most 0.95, preferably at least substantially 0.9, for a battery pack 38a with 4 Ah electrical charge capacity.

The ratio of the minimum distance 46a between the center of gravity of the battery pack 40a, when arranged on the grinding tool 10a, and the drive axis 30a to the maximum longitudinal extension 24a of the tool holder 24a is at least 0.95 and at most 1.05, preferably at least substantially 1.0, for a battery pack 38a with 8 Ah electrical charge capacity.

The ratio of the minimum distance 46a between the center of gravity of the battery pack 40a, when arranged on the grinding tool 10a, and the drive axis 30a to the maximum longitudinal extension 24a of the tool holder 24a is at least 1.0 and at most 1.1, preferably at least substantially 1.07, for a battery pack 38a with 12 Ah electrical charge capacity.

An overall center of gravity 176a of the hand-held power tool system 36a is disposed in the handle recess 20a of the bow handle 18a. The overall center of gravity 176a of the hand-held power tool system 36a relates to the hand-held power tool 50a with the battery pack 38a and is free of the dust collection container 262a and/or a protective device 120a. A minimum distance (not shown here) of the overall center of gravity 176a from the separation plane 146a of the handle housing 52a, from the main extension plane 64a of the handle housing 52a and/or from the main extension plane 42a of the bow handle 18a is less than the maximum transverse extension 200a of the handle housing 52a, in particular of the bow handle 18a, starting from the separation plane 146a of the handle housing 52a, the main extension plane 64a of the handle housing 52a and/or the main extension plane 42a of the bow handle 18a. It is conceivable that the overall center of gravity 176a is arranged in the separation plane 146a of the handle housing 52a, in the main extension plane 64a of the handle housing 52a and/or in the main extension plane 42a of the bow handle 18a.

A minimum distance 302a of the drive axis 30a to the overall center of gravity 176a has a value of at least 55 mm to at least 70 mm, in particular depending on the weight of the battery pack 38a. The minimum distance 302a between the drive axis 30a and the overall center of gravity 176a has a value of at most 65 mm to at most 75 mm, depending, in particular, on the weight of the battery pack 38a.

A maximum distance 304a of the tool holder 12a to the overall center of gravity 176a in the direction of the drive axis 30a has a value of at least 45 mm to at least 50 mm, depending, in particular, on the weight of the battery pack 38a. The maximum distance 304a between the tool holder 12a and the overall center of gravity 176a in the direction of the drive axis 30a has a value of at most 52 mm to at most 55 mm, depending, in particular, on the weight of the battery pack 38a.

Preferably, the overall center of gravity 176a of the hand-held power tool system 36a with at least one battery pack 38a with a single-layer battery cell arrangement is disposed within the handle recess 20a of the bow handle 18a. A position of the overall center of gravity 176a of the hand-held power tool system 36a with a battery pack 38a with a single-layer battery cell arrangement is such that the hand-held power tool 50a can be placed on the tool holder 12a, in particular without tilting.

By way of example, the minimum distance 302a of the drive axis 30a from the overall center of gravity 176a is at least substantially 60 mm for a battery pack 38a with 4 Ah electrical charge capacity and at least substantially 72 mm for a battery pack 38a with 8 Ah electrical charge capacity.

By way of example, the maximum distance 304a from the tool holder 12a to the overall center of gravity 176a in the direction of the drive axis 30a is at least substantially 50 mm for a battery pack 38a with 4 Ah electrical charge capacity and at least substantially 53 mm for a battery pack 38a with 8 Ah electrical charge capacity.

A ratio of the minimum distance 46a between the center of gravity of the battery pack 40a, when arranged on the grinding tool 10a, and the drive axis 30a to the maximum longitudinal extension 22a of the handle recess 20a of the bow handle 18a is at least 2.0 and at most 3.0.

The ratio of the minimum distance 46a between the center of gravity of the battery pack 40a, when arranged on the grinding tool 10a, and the drive axis 30a to the maximum longitudinal extension 22a of the handle recess 20a of the bow handle 18a is at least 2.0 and at most 2.5, preferably at least substantially 2.2, for a battery pack 38a with 4 Ah electrical charge capacity.

The ratio of the minimum distance 46a between the center of gravity of the battery pack 40a, when arranged on the grinding tool 10a, and the drive axis 30a to the maximum longitudinal extension 22a of the handle recess 20a of the bow handle 18a is at least 2.2 and at most 2.6, preferably at least substantially 2.4, for a battery pack 38a with 8 Ah electrical charge capacity.

The ratio of the minimum distance 46a between the center of gravity of the battery pack 40a when arranged on the grinding tool 10a and the drive axis 30a to the maximum longitudinal extension 22a of the handle recess 20a of the bow handle 18a is at least 2.4 and at most 2.8, preferably at least substantially 2.6, for a battery pack 38a with an electrical charge capacity of 12 Ah.

The hand-held power tool 50a has a hand-held power tool apparatus 48a, in particular a hand-held grinding tool apparatus. The hand-held power tool apparatus 48a has the housing unit 16a.

The drive housing 54a provides the drive axis 30a of the drive unit 14a. In particular, the motor housing 78a provides the drive axis 30a. The motor housing 78a has a motor mount, in the central longitudinal axis of which a motor axis 260a comes to rest. The drive axis 30a is defined by the motor axis 260a. In particular, the central longitudinal axis is congruent with the drive axis 30a. The drive housing 54a is coupled to the handle housing 52a.

On a surface 56a of an upper side 58a of the drive housing 54a, the drive housing 54a has a central web 60a that is raised relative to the surface 56a. An end 62a of the handle housing 52a is arranged above the central web 60a. The central web 60a slopes down onto the surface 56a in both directions, starting from a main extension plane 64a of the handle housing 52a and extending perpendicularly to the main extension plane 64a of the handle housing 52a.

Two screw bosses 280a of the drive housing 54a are arranged on lateral walls 278a of the central web 60a. In particular, the central web 60a protrudes in a radial direction relative to the drive axis 30a, wherein a further screw boss 282a of the drive housing 54a is arranged in the protruding region of the central web 60a.

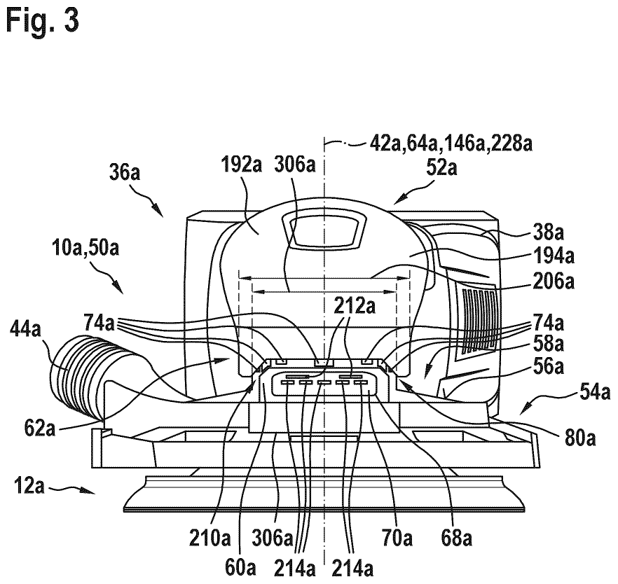

A maximum transverse extension 306a of the central web 60a is smaller than a maximum total transverse extension 204a of the handle housing 52a. The maximum transverse extension 306a of the central web 60a runs at least substantially perpendicular to the main extension plane 42a of the bow handle 18a, to the main extension plane 64a of the handle housing 52a, to the separation plane 146a and/or to the drive axis 30a. The maximum transverse extension 306a of the central web 60a runs at least substantially parallel to the tool holder surface 102a of the tool holder 12a. The maximum transverse extension 306a of the central web 60a is smaller than a maximum transverse extension 206a of the handle housing 52a at the end 62a of the central web 60a arranged above the central web 60a (see FIG. 3). The end 62a of the handle housing 52a is arranged above the central web 60a relative to the tool holder 12a and/or the surface 56a.

The central web 60a has a main extension axis 208a. The main extension axis 208a of the central web 60a runs at least substantially perpendicular to the drive axis 30a. The main extension axis 208a of the central web 60a runs at least substantially parallel to the main extension plane 42a of the bow handle 18a, to the main extension plane 64a of the handle housing 52a, to the separation plane 146a and/or to the tool holder surface 102a. The main extension axis 208a of the central web 60a runs in the main extension plane 42a of the bow handle 18a, in the main extension plane 64a of the handle housing 52a and/or in the separation plane 146a.

The central web 60a runs, in particular at least in the direction of the main extension axis 208a of the central web 60a, over a large part of the surface 56a, preferably over at least 50%, preferably over at least 75% and particularly preferably over 90% of the surface 56a. The upper side 58a, preferably the surface 56a, is arranged facing away from the tool holder 12a. The central web 60a has a curvature, preferably a curvature adapted to the surface 56a, in the longitudinal direction, in particular in the direction of the main extension axis 208a of the central web 60a. Alternatively, however, it is also conceivable that the central web 60a has no curvature in the longitudinal direction.

The handle housing 52a covers the central web 60a at least partially on both sides along an axis extending perpendicularly to the main extension plane 64a of the handle housing 52a. The handle housing 52a covers the central web 60a in the directions extending perpendicular to the main extension plane 64a of the handle housing 52a on both sides at a height of at least 10%. It is also conceivable that the handle housing 52a largely covers the central web 60a at a height on both sides in the directions perpendicular to the main extension plane 64a of the handle housing 52a, in particular at least 50%, preferably at least 70% and preferably at least 90%. The central web 60a is free from being covered by the handle housing 52a in the longitudinal direction.

An end 62a of the handle housing 62a facing the central web 60a, in particular the end 62a already mentioned above, preferably an end 62a substantially surrounding the drive housing 54a in a ring-like manner, is arranged at a distance from the drive housing 54a, in particular at a radial and axial distance. The end 62a is arranged at a distance from the surface 56a.

The motor housing 78a is arranged on the central web 60a. The end 62a surrounds the motor housing 78a in a ring-like manner. The motor housing 78a is arranged on a side of the central web 60a facing away from the tool holder 12a, in particular arranged above the central web 60a relative to the tool holder 12a. The motor housing 78a is enclosed by the handle housing 52a in a plane perpendicular to the drive axis 30a. The motor housing 78a is at least substantially completely enclosed by the handle housing 52a in a radial direction starting from the drive axis 30a. The motor housing 78a is at least partially integrally formed with the central web 60a. The handle housing 52a, in particular the end 62a of the handle housing 52a, is arranged at a distance from the drive housing 54a, in particular from the motor housing 78a.

The end 62a of the handle housing 52a facing the central web 60a is adjusted in terms of shape to the drive housing 54a, in particular the central web 60a and/or the surface 56a. The end 62a has two recesses 210a for the central web 60a. It is conceivable that the end 62a has a constant distance from the drive housing 54a in the direction of the drive axis 30a. Alternatively, however, it is also conceivable that a distance between the end 62a and the drive housing 54a varies in the direction of the drive axis 30a.

The central web 60a has a receptacle 68a for a user interface 70a. Alternatively or additionally, it is conceivable that the central web 60a has the receptacle 68a for a communication module 72a. The user interface 70a and/or the communication module 72a are/is part of the hand-held power tool 50a, in particular the grinding tool 10a, preferably the hand-held power tool apparatus 48a.

The communication module 72a can comprise one or more data transmission technologies, for example Bluetooth, NFC or the like. Alternatively, it is conceivable that the hand-held power tool 50a, in particular the hand-held power tool apparatus 48a, is free of a communication module 72a.

The receptacle 68a is formed as a recess in the central web 60a. The receptacle 68a is arranged on a side of the motor housing 78a facing away from the bow handle 18a. The receptacle 68a is arranged on a side of the handle housing 52a facing away from the battery pack interface 218a of the hand-held power tool 50a. The battery pack interface 218a is arranged on a side of the hand-held power tool 50a, in particular the grinding tool 10a, facing away from the user interface 70a.

In this example, the user interface 70a has two input elements 212a. Alternatively, however, it is also conceivable that the user interface 70a has only one input element 212a or more than two input elements 212a. The input elements 212a of the user interface 70a are here exemplarily designed as buttons. Alternatively, it is conceivable that at least one of the input elements 212a is designed as a rotary wheel, a switch or the like. By way of example, the hand-held power tool 50a can be switched on and/or off, a rotational speed of the hand-held power tool 50a, preferably of the grinding tool 10a, can be adjusted or the like via the user interface 70a, in particular the input elements 212a.

The user interface 70a has five output elements 214a in this example. Alternatively, it is conceivable that the user interface 70a has fewer or more than four output elements 214a. The output elements 214a are designed as light elements, in particular LEDs. Alternatively, it is conceivable that at least one of the output elements 214a is designed as a display or the like. By way of example, a rotational speed of the hand-held power tool 50a, preferably of the grinding tool 10a, a state of charge of the battery pack 38a, a device status of the hand-held power tool 50a or the like can be output via the user interface 70a, in particular via at least one of the output elements 214a.

The user interface 70a is connected by data technology to a control unit 216a of the hand-held power tool 50a, in particular the grinding tool 10a, preferably by cable and/or wirelessly. The control unit 216a is provided for controlling the drive unit 14a. In particular, the control unit 216a comprises at least one processor and a memory element as well as an operating program stored on the memory element. The storage element is designed as a digital storage medium, for example as a hard disk or the like. The control unit 216a is arranged in the handle housing 52a.

The communication module 72a is configured to communicate with another device, for example a smartphone, a laptop, a server, a cloud, a gateway or the like. The communication module 72a is connected to the control unit 216a and/or the user interface 70a by data, in particular wirelessly and/or by cable.

The communication module 72a is designed and in particular arranged separately from the user interface 70a. In this example, the communication module 72a is arranged in the handle housing 52a, in particular in the bow handle 18a. The communication module 72a is arranged between the motor housing 78a and the battery pack interface 218a. The communication module 72a is arranged on a side of the handle housing 52a on which the battery pack interface 218a is arranged. It is also conceivable that the communication module 72a is part of the control unit 216a. Alternatively, it is conceivable that the communication module 72a is arranged in a support 220a of the handle housing 52a on the drive housing 54a or in another position that appears to a person skilled in the art to be reasonable. Alternatively, it is also conceivable that the communication module 72a is part of the user interface 70a.

The hand-held power tool 50a has several cooling air inlet openings 266a. Alternatively, it is conceivable that the hand-held power tool 50a has only one cooling air inlet opening 266a. The cooling air inlet openings 266a are arranged here as an example on the handle housing 52a, in particular on the bow handle 18a. The cooling air inlet openings 266a are arranged on a wall of the handle housing 52a delimiting the handle recess 20a. The cooling air inlet openings 266a are arranged on a wall of the handle housing 52a facing the tool holder 12a and delimiting the handle recess 20a. Alternatively, it is also conceivable that the cooling air inlet openings 266a are arranged on a wall that is closest to the battery pack interface 218a and delimits the handle recess 20a. Alternatively, however, it is also conceivable that the cooling air inlet openings 266a are arranged at the drive housing 54a or at another position on the handle housing 52a that would appear to a person skilled in the art to be reasonable.

The hand-held power tool 50a has a motor fan 268a. The motor fan 268a is arranged in the drive housing 54a, in particular in the motor housing 78a. The motor fan 268a is provided for cooling the drive unit 14a, in particular the electric motor 190a. It is also conceivable that the control unit 216a can be cooled by means of the motor fan 268a. In particular, the motor fan 268a is intended to draw in ambient air via the cooling air inlet openings 266a. The motor fan 268a can be driven by the drive unit 14a.

The drive housing 54a has several air outlet openings 74a, which are at least partially covered by the handle housing 52a, in particular as viewed at least in a respective main outlet direction 76a of the air outlet openings 74. Alternatively, however, it is conceivable that the drive housing 54a has only one air outlet opening 74, which is at least partially covered by the handle housing 52a, in particular as viewed in at least one main outlet direction 76a of the air outlet opening 74a. The motor fan 268a is intended to direct the air drawn in via the cooling air inlet openings 266a via the drive unit 14a to the air outlet openings 74a and, in particular, to blow the engine exhaust air out of the air outlet openings 74a.

The handle housing 52a is free of air outlet openings. The drive housing 54a, in particular the motor housing 78a, has cooling air inlet openings 270a. The cooling air inlet openings 270a of the motor housing 78a are arranged on a side of the motor housing 78a facing away from the tool holder 12a. The cooling air inlet openings 270a of the motor housing 78a are arranged within the handle housing 52a, in particular within the palm handle 160a. Cooling air drawn into the motor housing 78a via the cooling air inlet openings 270a of the motor housing 78a can be introduced via the cooling air inlet openings 270a on the handle housing 52a.

The air outlet openings 74a are at least partially covered by the handle housing 52a, at least when viewed in a plane extending perpendicular to the drive axis 30a. It is conceivable that the handle housing 52a covers at least most of the air outlet openings 74a, preferably at least 50%, preferably at least 75% and particularly preferably at least 90%, especially when viewed in a plane perpendicular to the drive axis 30a. It is also conceivable that the handle housing 52a completely covers the air outlet openings 74a, in particular when viewed in a plane perpendicular to the drive axis 30a. The air outlet openings 74a are covered by the end 62a of the handle housing 52a, in particular when viewed in a plane perpendicular to the drive axis 30a.

The motor housing 78a has the air outlet openings 74a. The air outlet openings 74a are arranged above the central web 60a relative to the tool holder 12a and/or the surface 56a. The air outlet openings 74a are arranged here, by way of example, at a distance from one another in a peripheral direction, which in particular runs in a plane perpendicular to the drive axis 30a.

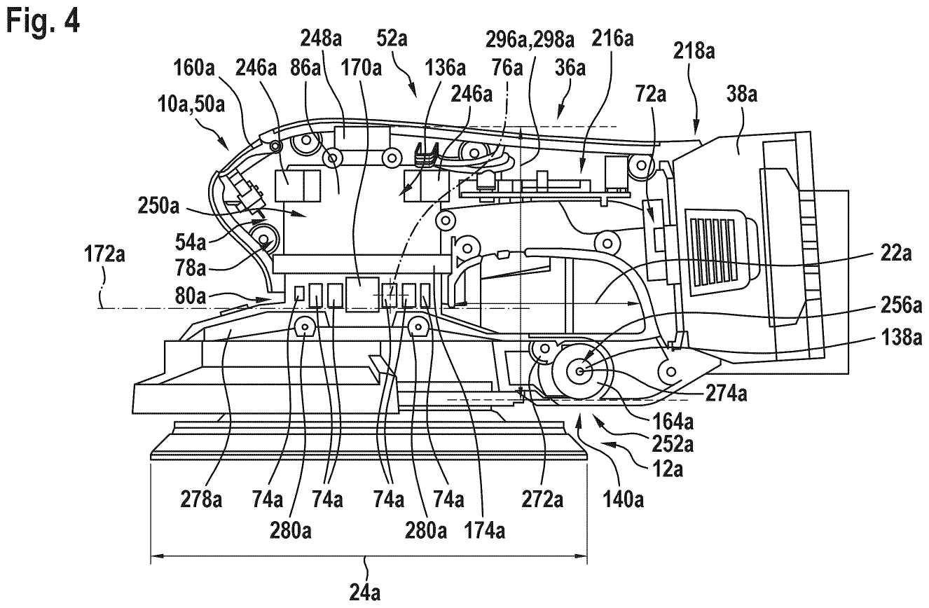

The main outlet directions 76a (in FIG. 4, only the main outlet direction 76a of one of the air outlet openings 74a is shown as an example) are determined by an arrangement and/or geometry of the respective air outlet opening 74a. As an example, the main outlet directions 76a here run at least substantially perpendicular to the drive axis 30a. Alternatively, however, it is also conceivable that the main outlet directions 76a run at an angle to the drive axis 30a, preferably inclined in the direction of the tool holder 12a.

An opening 80a for air to escape from the air outlet openings 74a is formed between the end 62a of the handle housing 52a facing the central web 60a and the drive housing 54a. The opening 80a is arranged opposite the upper side 58a. The opening 80a is formed by the spaced apart arrangement of the end 62a of the handle housing 52a with respect to the drive housing 54a, preferably the motor housing 78a.

The drive housing 54a has a closed cable duct 82a. At least a part, in particular a large part, preferably at least 50%, preferably at least 70%, of the cable duct 82a is covered by the handle housing 52a, in particular when viewed in a plane extending perpendicular to the drive axis 30a.

An open end 222a of the cable duct 82a is arranged at the receptacle 68a. A further open end 224a of the cable duct 82a is arranged in an inner region 226a of the handle housing 52a. The cable duct 82a runs from the receptacle 68a into the inner region 226a of the handle housing 52a. The cable duct 82a runs, in particular in the direction of the drive axis 30a, over the entire motor housing 78a.

The hand-held power tool 50a and/or the hand-held power tool apparatus 48a has an electrical connecting unit (not shown here). The electrical connecting unit has at least one electrical connecting element, for example a cable. The electrical connecting unit, in particular the electrical connecting element, is intended to connect the user interface 70a to the control unit 216a, in particular at least in terms of data and/or control. The user interface 70a can be supplied with electrical power via the electrical connecting unit, preferably via the at least one electrical connecting element and/or a further electrical connecting element of the electrical connecting unit.

The cable duct 82a is provided for receiving at least a part of the electrical connecting unit, in particular at least the electrical connecting element and/or the further electrical connecting element. The electrical connecting unit, in particular the at least one electrical connecting element and/or the further electrical connecting element, is/are at least partially arranged in the cable duct 82a. The receptacle 68a has at least one electrical connection (not shown here) for the user interface 70a. At least the electrical connecting element and/or the further electrical connecting element is/are connected to the terminal.

The drive housing 54a has at least two housing shells 84a, 86a. The drive housing 54a has a shell construction with the two housing shells 84a, 86 as half shells. The two housing shells 84a, 86a of the drive housing 54a are interconnected in a drive housing separation plane 228a of the drive housing 54a. The drive housing separation plane 228a runs at least substantially parallel to the separation plane 146a of the handle housing 52a. It is conceivable that the drive housing separation plane 228a corresponds to the separation plane 146a of the handle housing 52a. Alternatively, however, it is also conceivable that the drive housing separation plane 228a runs at an angle to the separation plane 146a.

The cable duct 82a is arranged between the housing shells 84a, 86a. The cable duct 82a runs within the outer walls of the housing shells 84a, 86a, in particular within at least one outer wall of one of the housing shells 84a, 86a. The cable duct 82a adjoins a contact surface of the outer walls of the two housing shells 84a, 86a. One housing shell 84a of the housing shells 84a, 86a has a groove 88a for the cable duct 82a. Another housing shell 86a of the housing shells 84a, 86a forms a lid (not shown here) for the cable duct 82a.

The cable duct 82a is arranged at least partially on, in particular in, the central web 60a. It is conceivable that at least part of the cable duct 82a runs through the central web 60a, for example at least 5%, 10% or 20% of the cable duct 82a.

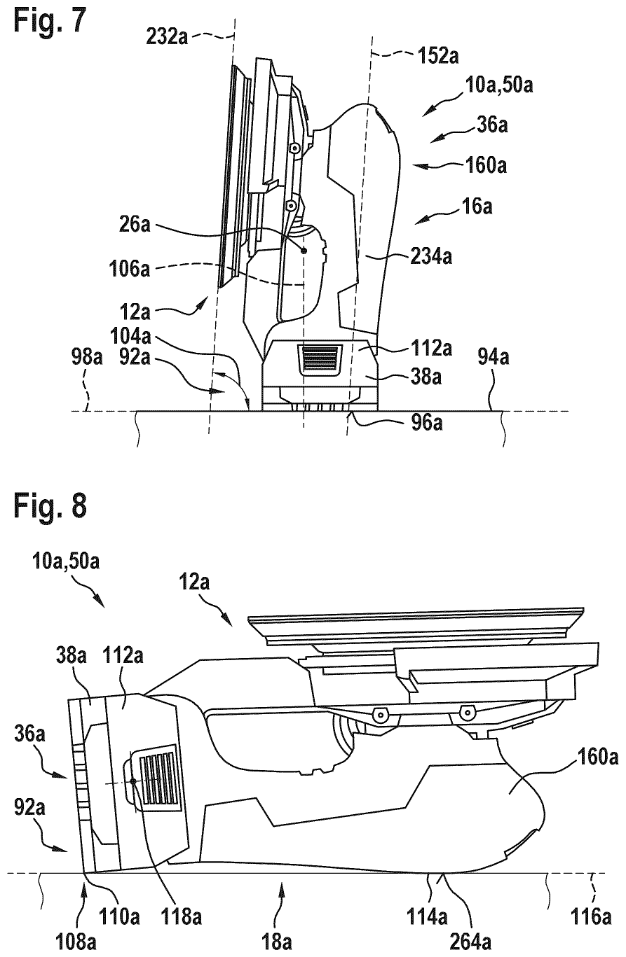

The hand-held power tool system 36a has a support unit 92a, which is designed for parking and/or resting the grinding tool 10a on a substrate 94a in at least one parking and/or resting position, wherein the battery pack 38a has a support surface 96a of the support unit 92a for the at least one parking and/or resting position. FIG. 7 shows the hand-held power tool system 36a in the parking and/or resting position.

The support surface 96a is here, by way of example, a continuous surface, which in particular rests on the substrate 94a in the at least one parking and/or resting position. The support surface 96a is here, by way of example, a flat surface. The substrate 94a can be, for example, a floor, a table or the like. In particular, the battery pack 38a has a rechargeable battery pack housing 112a. The rechargeable battery pack housing 112a has the support surface 96a.

The battery pack 38a has a hand-held power tool interface 230a for an electrical connection to the hand-held power tool 50a, in particular the grinding tool 10a. The hand-held power tool interface 230a is intended to be arranged on the battery pack interface 218a. The support surface 96a is arranged on a side of the battery pack 38a facing away from the hand-held power tool interface 230a.

The tool holder 12a and/or the tool 178a are/is spaced apart from the substrate 94a when the tool 178a is arranged at the tool holder 12a in the parking and/or resting position. In the parking and/or resting position, the grinding tool 10a can be set down solely via the support surface 96a. In the parking and/or resting position, the grinding tool 10a is at a distance from the substrate 94a. In the parking and/or resting position, the grinding tool 10a is connected to the substrate 94a via the battery pack 38a and can preferably be placed on the substrate 94a. In the parking and/or resting position, only the support surface 96a on the battery pack 38a of the hand-held power tool system 36a is in contact with the substrate 94a.

A main extension plane 98a of the support surface 96a runs to the main extension plane 232a of the tool holder surface 102a of the tool holder 12a at an angle 104a other than 90°. A main extension axis (not shown here) of the hand-held power tool 50a, in particular of the grinding tool 10a, runs at an angle other than 90° to the main extension plane 98a of the support surface 96a in the parking and/or resting position. The tool holder surface 102a runs at least substantially parallel to the main extension axis of the hand-held power tool 50a, in particular the grinding tool 10a. Alternatively, it is conceivable that the tool holder surface 102a runs at an angle to the main extension axis of the hand-held power tool 50a, in particular the grinding tool 10a.

In particular, a handle axis 152a of the handle housing 52a runs at an angle other than 900 to the main extension plane 98a of the support surface 96a in the parking and/or resting position. The handle axis 152a is defined by the bow handle 18a. The handle axis 152a runs in the separation plane 146a and/or in the main extension plane 64a of the handle housing 52a, in particular in the main extension plane 42a of the bow handle 18a. The handle axis 152a corresponds to a main extension axis of a handle tube 234a of the bow handle 18a.

The main extension plane 232a of the tool holder surface 102a and the main extension plane 98a of the support surface 96a include an angle 104a which is greater than 80°. The angle 104a included by the main extension plane 232a of the tool holder surface 102a and the main extension plane 98a of the support surface 96a has a value of less than 90° and greater than 80°. Particularly preferably, the angle 104a enclosed by the main extension plane 98a of the support surface 96a and the main extension plane 232a of the tool holder surface 102a has a value of at least substantially 86°.

The tool holder 12a, preferably the tool holder surface 102a, is inclined in a direction facing away from the substrate 94a in the parking and/or resting position. A normal 106a of the main extension plane 98a of the support surface 96a intersects the battery pack 38a and the center of gravity 26a of the grinding tool 10a.

The support unit 92a is configured for parking and/or resting the grinding tool 10a on the substrate 94a in at least one further parking and/or resting position, wherein the battery pack 38a has a further support surface 108a of the support unit 92a for the further parking and/or resting position. FIG. 8 shows the hand-held power tool system 36a in the further parking and/or resting position.

In the further parking and/or resting position, the tool holder surface 102a runs at least substantially parallel to a support plane 116a of the further parking and/or resting position and/or to the flat substrate 94a. In the further parking and/or resting position, the drive axis 30a runs at least substantially perpendicular to the support plane 116a of the further parking and/or resting position. An edge 110a of the rechargeable battery pack housing 112a of the battery pack 38a forms the further support surface 108a. The edge 110a is arranged facing away from the tool holder 12a.

A main extension axis 118a of the battery pack 38a runs at least substantially perpendicular to the main extension axis of the grinding tool 10a. The edge 110a of the rechargeable battery pack housing 112a runs at least substantially perpendicular to the main extension axis of the hand-held power tool 50a, in particular the grinding tool 10a.

The grinding tool 10a has only one support point 114a, which comes to lie in the support plane 116a of the further parking and/or resting position. The support point 114a is located on the handle housing 52a. Alternatively, it is also conceivable that the support point 114a is located on the drive housing 54a. The support point 114a of the grinding tool 10a is arranged on a side of the handle housing 52a facing away from the tool holder 12a. The support point 114a is located on a surface 264a of the palm handle 160a. The palm handle 160a has a round shape. The surface 264a of the palm handle 160a, on which the support point 114a is arranged, is curved. Alternatively, however, it is also conceivable that the surface 264a of the palm handle 160a, on which the support point 114a is arranged, is flat.

In the further parking and/or resting position, the further support surface 108a and the support point 114a of the grinding tool 10a are situated in the support plane 116a of the further parking and/or resting position. In the further parking and/or resting position, the hand-held power tool system 36a is in contact with the substrate 94a via the further support surface 108a on the battery pack 38a and via the support point 114a on the grinding tool 10a.

The hand-held power tool apparatus 48a has the previously mentioned protective device 120a, in particular a wall protection ring, for collision protection of the tool 178a that can be arranged on the hand-held power tool 50a and/or the tool holder 12a with objects in a working environment of the hand-held power tool 50a. The protective device 120a is designed in particular as a protective ring. The protective device 120a is preferably configured as a bumper for the hand-held power tool 50a. In particular, the protective device 120a is intended to counteract a stop of the tool holder 12a and/or the tool 178a arranged on the tool holder 12a against walls or the like in the working environment.

The protective device 120a has a screen unit 122a and/or a light guide unit 124a for at least one light source 132a.

The protective device 120a is arranged on the drive housing 54a in at least one operating state. The protective device 120a is provided for an arrangement on the fan housing 166a. The screen unit 122a is provided for shielding an area from an incident light from the at least one light source 132a. The screen unit 122a has several screen elements 100a. Alternatively, it is conceivable that the screen unit 122a has only one screen element 100a. The screen elements 100a are designed as opaque components. It is also conceivable that the screen elements 100a are designed as reflectors, for example as mirrors, or the like.

The protective device 120a has a base element 236a. The base element 236a has several windows 276a. The operator can look at the workpiece through the windows 276a when processing the workpiece. Alternatively, however, it is also conceivable that the base element 236a is formed without windows 276a.

The screen unit 122a, in particular the screen elements 100a, are formed integrally with the base element 236a. The screen unit 122a, in particular the screen elements 100a, is/are formed by the base element 236a of the protective device 120a.

Alternatively, it is also conceivable that the screen unit 122a, in particular the screen elements 100a, is/are formed separately from the base element 236a. In particular, it is alternatively conceivable that the screen unit 122a, preferably the screen elements 100a, is/are attachable to the base element 236a, preferably detachably. It is also conceivable that the screen unit 122a, in particular the screen elements 100a, can be arranged adjustably on the base element 236a, preferably in order to adapt a cut-off area by the screen unit 122a.

The light guide unit 124a is arranged on the base element 236a. The light guide unit 124a here has, for example, three light guide elements 238a. Alternatively, it is conceivable that the light guide unit 124a has more or fewer than three light guide elements 238a. The light guide unit 124a is intended to guide and/or radiate light from the at least one light source 132a. The light guide elements 238a are formed, for example, as transparent fibers, tubes or rods. The light guide elements 238a are exemplarily formed here as emitting elements, in particular as light-scattering elements, for example in the form of a roughening, a scattering glass, plastic or ceramic plate, a scattering plastic film or the like.

The screen unit 122a is provided for blocking a light emission of at least one light source 132a at least in the direction of an intended operator side. The screen unit 122a is provided for blocking a light emission of the at least one light source 132a in a direction facing away from the tool holder 12a.

It is conceivable that the protective device 120a has a light source unit 126a. In this example, the light source unit 126a has two light sources 132a. Alternatively, it is also conceivable that the light source unit 126a has a number of light sources 132a other than two, for example only one light source 132a or more than two light sources 132a. Furthermore, it is alternatively conceivable that the protective device 120a is free of a light source unit 126a. The light source unit 126a, in particular the light sources 132a, is/are arranged on the base element 236a. The light sources 132a are formed, for example, as LEDs, as incandescent lamps or as another illuminant that would appear useful to a person skilled in the art. Alternatively, it is also conceivable that the hand-held power tool 50a comprises at least one of the light sources 132a.

It is also conceivable that the protective device 120a has at least one energy source 128a for at least one light source 132a. In this example, the protective device 120a has two energy sources 128a. One of the energy sources 128a is assigned to each of the light sources 132a. Alternatively, however, it is also conceivable that the protective device 120a has only one energy source 128a or more than two energy sources 128a or is designed without energy sources 128a. The energy sources 128a are designed, for example, as batteries, rechargeable batteries or the like.

The energy sources 128a are provided for supplying energy to the respective light source 132a, in particular the light source unit 126a. The energy sources 128a are connected to the light sources 132a, in particular the light source unit 126a, at least in one operating state. Alternatively or additionally, however, it is also conceivable that the light sources 132a, in particular the light source unit 126a, are/can be supplied with electrical power via the hand-held power tool 50a, in particular the grinding tool 10a, for example via an electrical plug connection between the protective device 120a and the hand-held power tool 50a.

The protective device 120a has here, by way of example, an operating element 130a for the light sources 132a, in particular the light source unit 126a. The at least one operating element 130a is arranged on the base element 236a. The at least one operating element 130a can, for example, be designed as a button, a rotary wheel, a switch or the like. The at least one operating element 130a can be used, for example, to switch the light sources 132a on and/or off and/or to set a lighting parameter, for example a light color, an intensity or the like.

Furthermore, it is conceivable that the protective device 120a has a sensor unit 134a for detecting an operation of the hand-held power tool 50a, in particular for activating at least one light source 132a during operation of the hand-held power tool 50a.

The sensor unit 134a is arranged on the base element 236a. The sensor unit 134a has at least one sensor element (not shown here), for example a vibration sensor or the like, for detecting operation of the hand-held power tool 50a, in particular the grinding tool 10a. The sensor unit 134a has control electronics (not shown here) for processing the sensor signals. The control electronics are connected to the light sources 132a for control purposes. The control electronics are intended to switch on the light sources 132a when an operation of the hand-held power tool 50a is detected. It is conceivable that the control electronics are part of the control unit 216a of the hand-held power tool 50a. Alternatively, however, it is also conceivable that the control electronics are formed separately from the control unit 216a.

The protective device 120a is formed at least in part from a thermoplastic elastomer. The base element 236a is formed at least in part from a thermoplastic elastomer. At least one surface 240a of the protective device 120a facing away from the hand-held power tool 50a, in particular of the base element 236a, is formed from a thermoplastic elastomer.

It is also conceivable that the protective device 120a has a protective layer consisting at least partially of a thermoplastic elastomer. The protective layer can be a sleeve placed over the base element 236a, a layer bonded to the base element 236a or the like. Alternatively or additionally, it is also conceivable that the protective layer is clamped, screwed or the like onto the base element 236a. Furthermore, it is also conceivable that the base element 236a is overmolded by the protective layer, in particular that the protective layer is injection-molded onto the base element 236a, for example in a two-component injection molding process.

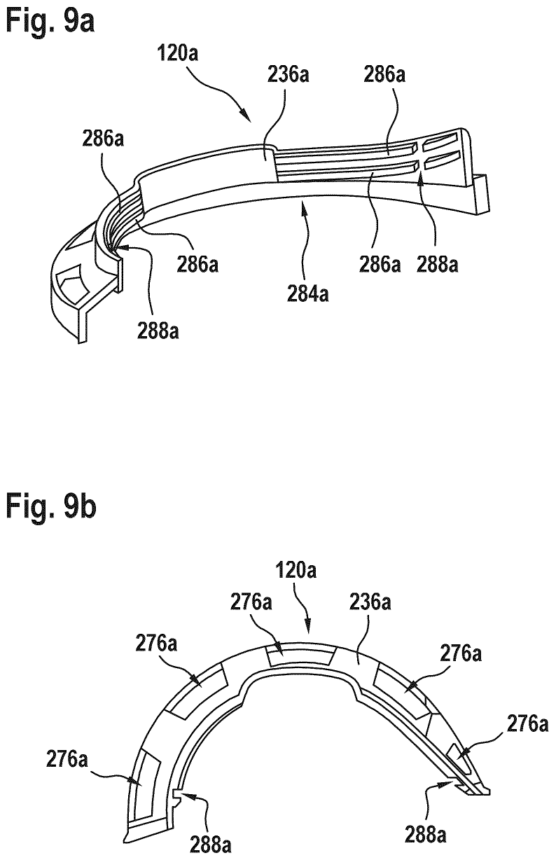

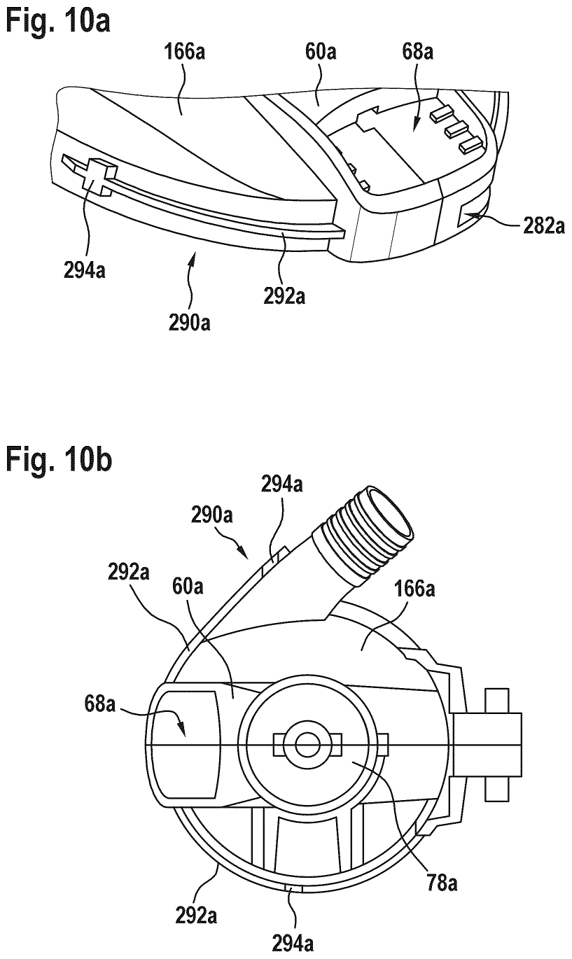

The protective device 120a has a fastening unit 284a for detachable fastening to the hand-held power tool 50a (see FIGS. 9a and 9b). The fastening unit 284a has two pairs of fixing rails 286a running parallel to one another. The fixing rails 286a each have a latching recess 288a. The hand-held power tool 50a, in particular the drive housing 54a, preferably the fan housing 166a, has a protective fastening unit 290a corresponding to the fastening unit 284a (see FIGS. 10a and 10b).

The protective fastening unit 290a has two fixing rails 292a. The fixing rails 292a of the protective fastening unit 290a are arranged between the fixing rails 286a of the fastening unit 284a when the protective device 120a is arranged on the hand-held power tool 50a. The fixing rails 286a of the fastening unit 284a and the fixing rails 292a of the protective fastening unit 290a are provided for fixing in an axial direction relative to one another, preferably with respect to the drive axis 30a. The protective fastening unit 290a has two latching elements 294a, in particular latching hooks or the like. The latching elements 294a are intended to cooperate with the latching recesses 288a of the fastening unit 284a to fasten the protective device 120a to the hand-held power tool 50a.

The protective device 120a has an asymmetrical basic shape, in particular adapted to a dust outlet 44a of the hand-held power tool 50a. A shape of the base element 236a deviates along its longitudinal extension in at least one section from a circular shape, preferably in a region of the dust outlet 44a.

The hand-held power tool apparatus 48a has a damping unit 136a, which couples the drive housing 54a to the handle housing 52a. The drive housing 54a has a cantilever 138a extending at least radially relative to the drive axis 30a. At least a part 140a of the damping unit 136a is arranged on the cantilever 138a. The housing shells 84a, 86 are screwed together on the cantilever 138a, in particular via a screw boss 274a of the housing shells 84a, 86a. A screw boss 272a of the handle housing shells 192a, 194a in the region of the cantilever 138a is arranged at a distance from the screw dome 274a of the housing shells 84a, 86a.

The damping unit 136a has several damping elements 164a, 170a, 246a, 248a. The damping elements 164a, 170a, 246a, 248a are formed from at least one elastic material, in particular an elastic plastic. The damping elements 164a, 170a, 246a, 248a can be formed as blocks, rings, ring segments, plates or the like.

At least some of the damping elements 164a, 170a, 246a, 248a are fixed between the drive housing 54a and the handle housing 52a by means of a clamp. It is also conceivable that the damping elements 164a, 170a, 246a, 248a have an adhesive layer for attachment to the drive housing 54a and/or to the handle housing 52a. Additionally or alternatively, it is conceivable that at least some of the damping elements 164a, 170a, 246a, 248a can be attached to the handle housing 52a and/or the drive housing 54a by means of damping element holders, for example recesses, retaining bolts or the like, and/or by means of a screw connection or the like.

The part 140a of the damping unit 136a on the cantilever 138a has here, by way of example, two damping elements 164a of the damping elements 164a, 170a, 246a, 248a. Alternatively, it is also conceivable that the part 140a of the damping unit 136a on the cantilever 138a has only one damping element 164a or more than two damping elements 164a.

The drive housing 54a is connected to the handle housing 52a via the damping elements 164a, 170a, 246a, 248a. The damping unit 136a is provided for vibration decoupling of the handle housing 52a from the drive housing 54a. The handle housing 52a is coupled to the drive housing 54a via two mutually different coupling regions 250a, 252a of the damping unit 136a. The handle housing 52a has two inner regions 226a, 254a mutually spaced, in each of which a part of the drive housing 54a is arranged. The two coupling regions 250a, 252a are arranged in the two inner regions 226a, 254a.

The cantilever 138a is arranged on a side of the drive housing 54a facing the battery pack interface 218a. The cantilever 138a is arranged inside the handle housing 52a, in particular in a further inner region 254a of the two inner regions 226a, 254a of the handle housing 52a. Viewed in a direction perpendicular to the drive axis 30a and extending in the separation plane 146a, the cantilever 138a forms an outermost point of the drive housing 54a. The cantilever 138a is at least partially enclosed by the handle housing 52a. It is also conceivable that the communication module 72a is arranged between the cantilever 138a and the battery pack interface 218a, in particular in the further inner region 254a.

The cantilever 138a has at least one damping element holder 256a for the damping elements 164a. The damping elements 164a are adapted to the damping element holder 256a in terms of shape. The damping element holder 256a has two retaining bolts for accommodating one of the annular damping elements 164a in each case. The damping element holder 256a is provided for accommodating the damping elements 164a perpendicular to the main extension plane 64a of the handle housing 52a, in particular to the main extension plane 42a of the bow handle 18a, and/or to the separation plane 146a. The cantilever 138a is here exemplarily T-shaped, in particular for accommodating the at least two damping elements 164a.

Alternatively, however, it is also conceivable, for example, that the damping element holder 256a is designed as a recess, in particular for receiving a damping element 164a designed as a block, plate or the like. The damping elements 164a are fixed to the damping element holder 256a by the handle housing 52a, in particular the handle housing shells 192a, 194a. Alternatively or additionally, however, it is also conceivable that the damping elements 164a are glued, screwed or the like to the damping element holder 256a.

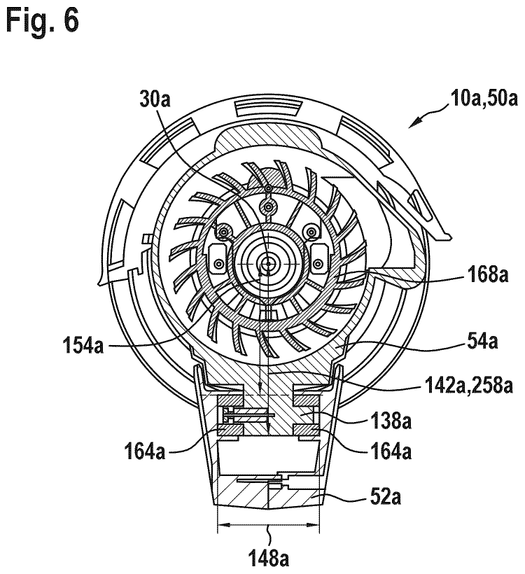

A maximum distance 142a of the cantilever 138a from the drive axis 30a is greater than a maximum distance 144a of the tool holder 12a from the drive axis 30a, in particular as viewed in a separation plane 146a of the handle housing 52a (see FIG. 6). A maximum distance 258a of the part 140a of the damping unit 136a on the cantilever 138a from the drive axis 30a is greater than the maximum distance 144a of the tool holder 12a from the drive axis 30a, in particular when viewed in the separation plane 146a of the handle housing 52a.

A ratio of a maximum transverse extension 148a of the part 140a of the damping unit 136a to a minimum distance 150a of the part 140a of the damping unit 136a from the handle axis 152a of the handle housing 52a is at least 0.9 and at most 1.05. The maximum transverse extension 148a of the part 140a of the damping unit 136a runs at least substantially perpendicular to the main extension plane 64a of the handle housing 52a, in particular the main extension plane 42a of the bow handle 18a, and/or the separation plane 146a. The maximum transverse extension 148a of the part 140a of the damping unit 136a runs at least substantially parallel to the tool holder surface 102a. The minimum distance 150a of the part 140a of the damping unit 136a from the handle axis 152a is measured parallel to the separation plane 146a, in particular to the main extension plane 42a of the bow handle 18a, preferably to the main extension plane 64a of the handle housing 52a.

The maximum transverse extension 148a of the part 140a of the damping unit 136a is here exemplarily at least 40 mm, preferably at least 45 mm. The maximum transverse extension 148a of the part 140a of the damping unit 136a is here exemplarily at most 60 mm, preferably at most 50 mm. The maximum transverse extension 148a of the part 140a of the damping unit 136a is defined by a maximum distance between the two damping elements 164a, in particular in a direction perpendicular to the main extension plane 42a of the bow handle 18a.

A ratio of the maximum transverse extension 148a of the part 140a of the damping unit 136a to the maximum height 34a of the grinding tool 10a is preferably at least 0.35, preferably at least 0.4. The ratio of the maximum transverse extension 148a of the part 140a of the damping unit 136a to the maximum height 34a of the grinding tool 10a is preferably at most 0.5, preferably at most 0.45.

The minimum distance 150a of the part 140a of the damping unit 136a from the handle axis 152a is preferably at least 45 mm, preferably at least 50 mm. The minimum distance 150a of the part 140a of the damping unit 136a from the handle axis 152a is preferably at most 60 mm, preferably at most 55 mm. Alternatively, however, it is also conceivable that the minimum distance 150a of the part 140a of the damping unit 136a from the handle axis 152a is less than 45 mm or greater than 60 mm.

A ratio of the maximum transverse extension 148a of the part 140a of the damping unit 136a to a minimum distance 154a of the part 140a of the damping unit 136a from the drive axis 30a is at least 0.7, preferably at least 0.73. The ratio of the maximum transverse extension 148a of the part 140a of the damping unit 136a to the minimum distance 154a of the part 140a of the damping unit 136a from the drive axis 30a is at most 0.8, preferably at most 0.75. The minimum distance 154a of the part 140a of the damping unit 136a from the drive axis 30a is measured parallel to the separation plane 146a, in particular to the main extension plane 42a of the bow handle 18a, preferably to the main extension plane 64a of the handle housing 52a.

The minimum distance 154a of the part 140a of the damping unit 136a from the drive axis 30a is preferably at least 55 mm, preferably at least 60 mm. The minimum distance 154a of the part 140a of the damping unit 136a from the drive axis 30a is preferably at most 70 mm, preferably at most 65 mm. Alternatively, however, it is also conceivable that the minimum distance 154a of the part 140a of the damping unit 136a from the drive axis 30a is less than 55 mm or greater than 70 mm.

A ratio of a maximum height 156a of the housing unit 16a to the minimum distance 150a of the part 140a of the damping unit 136a on the cantilever 138a from the handle axis 152a of the handle housing 52a is at most 2.25. The maximum height 156a of the housing unit 16a runs in the separation plane 146a, in particular in the main extension plane 64a of the handle housing 52a, preferably in the main extension plane 42a of the bow handle 18a.

The maximum height 156a of the housing unit 16a runs parallel to the drive axis 30a. The maximum height 156a of the housing unit 16a is here exemplarily at least 90 mm, preferably at least 100 mm. The maximum height 156a of the housing unit 16a is here exemplarily a maximum of 120 mm, preferably a maximum of 110 mm. Alternatively, however, it is also conceivable that the maximum height 156a of the housing unit 16a in the direction of the drive axis 30a is less than 90 mm or greater than 120 mm.

A ratio of a maximum extension 296a of the damping unit 136a, in particular a maximum distance 298a of the damping elements 164a, 170a, 246a, 248a, in the direction of the drive axis 30a to the maximum height 156a of the housing unit 16a is at least 0.8, preferably at least 0.85. A ratio of the maximum extension 296a of the damping unit 136a, in particular the maximum distance 298a of the damping elements 164a, 170a, 246a, 248a, in the direction of the drive axis 30a to the maximum height 34a of the grinding tool 10a is at least 0.7, preferably at least 0.75. The maximum extension 296a of the damping unit 136a, in particular the maximum distance 298a of the damping elements 164a, 170a, 246a, 248a, in the direction of the drive axis 30a is here exemplarily at least 85 mm, preferably at least 90 mm (see FIG. 4).

A ratio of the minimum distance 154a of the part 140a of the damping unit 136a from the drive axis 30a in a direction perpendicular to the drive axis 30a to a maximum longitudinal extension 158a of the housing unit 16a is greater than 0.3. The maximum longitudinal extension 158a of the housing unit 16a runs perpendicular to the drive axis 30a. The maximum longitudinal extension 158a of the housing unit 16a runs at least substantially parallel to the tool holder surface 102a. The maximum longitudinal extension 158a of the housing unit 16a runs in the separation plane 146a, preferably in the main extension plane 64a of the handle housing 52a, in particular the main extension plane 42a of the bow handle 18a.

The maximum longitudinal extension 158a of the housing unit 16a is preferably at least 175 mm, preferably at least 180 mm. The maximum longitudinal extension 158a of the housing unit 16a is preferably at most 190 mm, preferably at most 185 mm. Alternatively, however, it is also conceivable that the maximum longitudinal extension 158a of the housing unit 16a is less than 175 mm or greater than 190 mm.

A ratio of the minimum distance 154a between the part 140a of the damping unit 136a and the drive axis 30a to the minimum distance 150a between the part 140a of the damping unit 136a and the handle axis 152a of the handle housing 52a is at least 1.2 and at most 1.3.

The bow handle 18a is supported on the drive housing 54a via the part 140a of the damping unit 136a and/or via the cantilever 138a to form the closed handle recess 20a of the bow handle 18a.

The portion 140a of the damping unit 136a and/or the cantilever 138a is arranged in the direction of the handle axis 152a at the level of the handle recess 20a. Viewed in the direction of the handle axis 152a, the part 140a of the damping unit 136a on the cantilever 138a and/or the cantilever 138a is arranged at least substantially completely within the maximum longitudinal extension 22a of the handle recess 20a.

The two damping elements 164a of the part 140a of the damping unit 136a on the cantilever 138a are arranged mutually spaced. The damping elements 164a are arranged on opposite sides of the cantilever 138a. The damping elements 164a are arranged on mutually different sides of the separation plane 146a, in particular the main extension plane 64a of the handle housing 52a, preferably the main extension plane 42a of the bow handle 18a. The damping elements 164a are arranged symmetrically identical relative to the separation plane 146a, in particular the main extension plane 64a of the handle housing 52a, preferably the main extension plane 42a of the bow handle 18a.

The cantilever 138a is arranged on the fan housing 166a. The cantilever 138a is at least partially integrally formed with the fan housing 166a. The cantilever 138a is arranged on a side of the fan housing 166a facing the battery pack interface 218a. The fan housing 166a is arranged between the motor housing 78a and the tool holder 12a. The extraction fan 168a is made of metal, in particular cast. Alternatively, however, it is also conceivable that the extraction fan 168a is made of plastic or a combination of plastic and metal.

The motor housing 78a and the fan housing 166a are at least partially formed integrally with one another. The fan housing 166a and the motor housing 78a have common housing shells 84a, 86a. The two housing shells 84a, 86a each have one half of the fan housing 166a and one half of the motor housing 78a.

Two further damping elements 170a of the damping unit 136a are arranged on the motor housing 78a, for example, such that the damping elements 170a are only partially enclosed by the handle housing 52a when viewed in a sectional plane 172a perpendicular to the drive axis 30a through the respective damping element 170a. Alternatively, however, it is also conceivable that the damping unit 136a has only one further damping element 170a or more than two further damping elements 170a.

The two further damping elements 170a are arranged between the handle housing 52a and the motor housing 78a. The two further damping elements 170a are arranged within the handle housing 52a. The two further damping elements 170a are arranged on opposite sides of the motor housing 78a, in particular on different housing shells 84a, 86a. The two further damping elements 170a are arranged on different sides of the separation plane 146a and/or the drive housing separation plane 228a. The two further damping elements 170a are arranged symmetrically to the separation plane 146a and/or to the drive housing separation plane 228a. The two further damping elements 170a are cube-shaped. The further damping elements 170a are arranged at the level of the air outlet openings 74a when viewed in the axial direction.

The damping unit 136a has two sealing elements 174a, in particular a sealing ring, in order to block an inlet of exhaust air into the handle housing 52a. The sealing elements 174a are arranged between the handle housing 52a and the drive housing 54a.

The sealing elements 174a are designed as circular arc segments. The sealing elements 174a are arranged within the handle housing 52a. The sealing elements 174a are arranged on opposite sides of the motor housing 78a, in particular on different housing shells 84a, 86a. The sealing elements 174a are arranged on different sides of the separation plane 146a and/or the drive housing separation plane 228a. The sealing elements 174a are arranged symmetrically to the separation plane 146a and/or to the drive housing separation plane 228a.

Alternatively, however, it is also conceivable that the damping unit 136a has only one sealing element 174a or more than two sealing elements 174a. The sealing elements 174a surround the motor housing 78a in a peripheral direction, which in particular runs in a plane perpendicular to the drive axis 30a, at least substantially completely, preferably in an angular range of at least 270°, preferably of at least 330° and particularly preferably of at least 350°.

The sealing elements 174a are provided to at least substantially completely fill a gap between the motor housing 78a and the handle housing 52a. The sealing elements 174a are formed from an elastic material, preferably an elastic plastic. The sealing elements 174a preferably have a material hardness different from that of the damping elements 164a, 170a, 246a, 248a. The material hardness of the sealing elements 174a is lower than a material hardness of the damping elements 164a, 170a, 246a, 248a. Alternatively, it is conceivable that the sealing elements 174a and the damping elements 164a, 170a, 246a, 248a have an identical material hardness. The sealing elements 174a are arranged above the air outlet openings 74a relative to the tool holder 12a. The sealing elements 174a are additionally provided to support and/or vibration decoupling of the handle housing 52a from the drive housing 54a.

The damping unit 136a has four additional damping elements 246a. Alternatively, however, it is also conceivable that the damping unit 136a has fewer than four additional damping elements 246a or more than four additional damping elements 246a. The additional damping elements 246a are arranged between the handle housing 52a and the motor housing 78a. The additional damping elements 246a are disposed within the handle housing 52a. The additional damping elements 246a are arranged uniformly in a peripheral direction of the motor housing 78a, which in particular runs in a plane perpendicular to the drive axis 30a.

In each case, two of the additional damping elements 246a are arranged on opposite sides of the motor housing 78a, in particular on different housing shafts 84a, 86a. In each case, two of the additional damping elements 246a are arranged on different sides of the separation plane 146a and/or the drive housing separation plane 228a.

The additional damping elements 246a are arranged symmetrically to the separation plane 146a and/or the drive housing separation plane 228a. The additional damping elements 246a are cube-shaped. The two sealing elements 174a are arranged between the further damping elements 170a and the additional damping elements 246a when viewed in the axial direction.

The damping unit 136a has a further additional damping element 248a. The further additional damping element 248a is provided for damping axial relative movements, in particular vibrations, relative to the drive axis 30a between the drive housing 54a and the handle housing 52a and/or for axial support between the handle housing 52a and the drive housing 54a. Alternatively or additionally, however, it is also conceivable that the further additional damping element 248a is provided for damping radial movements and/or for radial support between the handle housing 52a and the drive housing 54a. The further additional damping element 248a is preferably arranged in an extension of the motor axis 260a, preferably between the motor housing 78a and the handle housing 52a.

The further additional damping element 248a is exemplary here in the form of a circular cylinder. Alternatively, however, it is also conceivable that the further additional damping element 248a is cube-shaped or the like. The further additional damping element 248a is arranged here in an exemplary prestressed manner between the drive housing 54a and the handle housing 52a.

The maximum extension 296a of the damping unit 136a, in particular the maximum distance 298a of the damping elements 164a, 170a, 246a, 248a, in the direction of the drive axis 30a is defined by a maximum distance between the further additional damping element 248a and the damping elements 164a in the direction of the drive axis 30a.

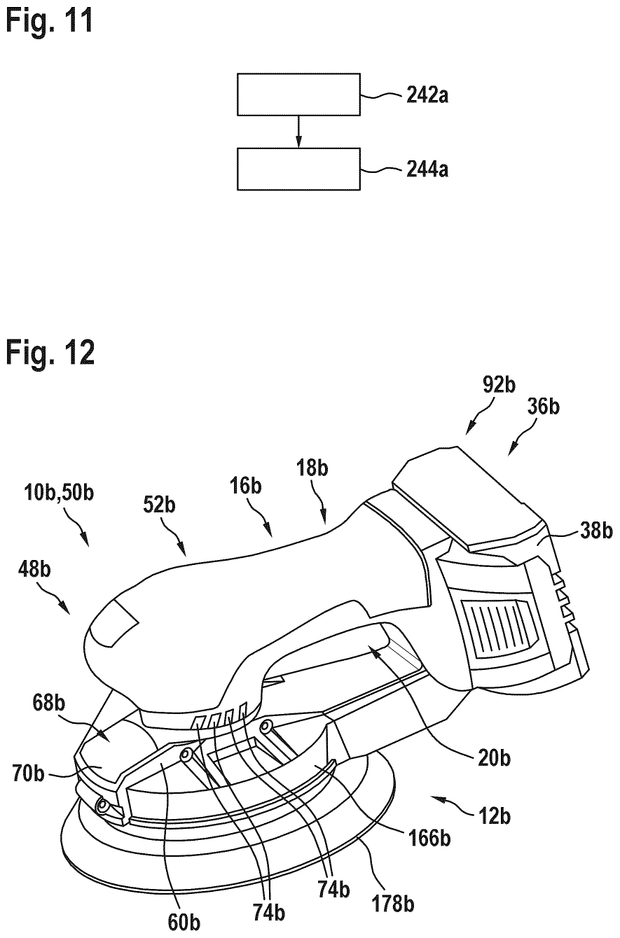

FIG. 11 shows a schematic sequence of a method for producing a hand-held power tool apparatus 48a, in particular the one mentioned above. The protective device 120a is manufactured at least partially from a thermoplastic elastomer.

In a process step, in particular a molding step 242a, the base element 236a is molded. In a process step, in particular an overmolding step 244a, the base element 236a is overmolded with a protective layer of thermoplastic elastomer. Alternatively, it is also conceivable that the base element 236a is already at least partially molded with a thermoplastic elastomer, in particular in the molding step 242a.

FIG. 12 shows a further embodiment example of the disclosure. The following descriptions and the drawings are substantially limited to the differences between the embodiment examples, wherein reference can, in principle, also be made, with respect to identically designated components, in particular with respect to components having the same reference numbers, to the drawings and/or the description of the other embodiment examples, in particular FIGS. 1 to 11. In order to distinguish the embodiment examples, the letter a is appended to the reference numbers of the embodiment example in FIGS. 1 to 11. In the embodiment example of FIG. 12, the letter a is replaced by the letter b.

FIG. 12 shows a hand-held power tool system 36b comprising a hand-held power tool 50b. The hand-held power tool 50b is designed as a grinding tool 10b. The hand-held power tool 50b is designed as a battery-powered grinding tool. Alternatively, however, it is also conceivable that the hand-held power tool 50b, in particular the grinding tool 10b, is designed as a mains-powered hand-held power tool. The grinding tool 10b is designed as a random orbital sander. Alternatively, however, it is also conceivable that the grinding tool 10b is designed as an orbital sander, a delta sander or the like.

The hand-held power tool 50b has a tool holder 12b, in particular a sanding pad, for accommodating a tool 178b. The hand-held power tool 50b has a drive unit (not shown here) for driving the tool holder 12b.

The hand-held power tool 50b has a housing unit 16b.

The housing unit 16b has a handle housing 52b and a fan housing 166b for accommodating an extraction fan. The fan housing 166b is designed as a metal housing, in particular as an aluminum housing. Alternatively, however, it is also conceivable that the fan housing 166b is at least partially designed as a plastic housing. The handle housing 52b has a bow handle 18b. The handle housing 52b is coupled to the fan housing 166b. A drive unit, in particular at least one electric motor, of the hand-held power tool 50b is arranged in the handle housing 52b.

A ratio of a maximum longitudinal extension of a handle recess 20b of the bow handle 18b to a maximum longitudinal extension of the tool holder 12b is at least 0.35 and at most 0.5. The bow handle 18b has a closed design. The handle recess 20b, viewed in the main extension plane of the bow handle 18b, is enclosed, in particular delimited, by walls of the handle housing 52b. The fan housing 166b lies directly against the handle housing 52b. The handle housing 52b has air outlet openings 74b.

The hand-held power tool 50b has a hand-held power tool apparatus 48b. The housing unit 16b is part of the hand-held power tool apparatus 48b. The fan housing 166b has, on a surface of an upper side of the fan housing 166b, a central web 60b that is raised relative to the surface. The central web 60b slopes toward the surface in both directions extending from a main extension plane (not shown here) of the handle housing 52b and perpendicular to the main extension plane of the handle housing 52b.

The hand-held power tool system 36b has a battery pack 38b for supplying power to the hand-held power tool 50b. The hand-held power tool system 36b has a support unit 92b, which is designed for parking and/or resting the grinding tool 10b on a substrate (not shown here) in at least one parking and/or resting position, wherein the battery pack 38b has a support surface of the support unit 92b for the at least one parking and/or resting position.

The hand-held power tool 50b has a receptacle 68b for a user interface 70b of the hand-held power tool 50b. The receptacle 68b is delimited by the handle housing 52b and the fan housing 166b.

What is claimed is:

1. A hand-held power tool, comprising:
a housing unit which has at least one handle housing and a drive housing which is coupled to the handle housing; and
a central web on a surface of an upper side of the drive housing, and raised relative to the surface.

2. The hand-held power tool according to claim 1, wherein the central web has a receptacle configured to receive a user interface and/or a communication module.

3. The hand-held power tool according to claim 2, wherein:
a user interface is accommodated in the receptacle;
the user interface has at least one input element; and
a rotational speed of the hand-held power tool can be set via the at least one input element.

4. The hand-held power tool according to claim 1, wherein:
the central web slopes down onto the surface in both directions starting from a main extension plane of the handle housing and perpendicular to the main extension plane of the handle housing; and
one end of the handle housing is arranged above the raised central web.

5. The hand-held power tool according to claim 4, wherein:
the handle housing at least partially covers the central web on both sides in directions running perpendicularly to the main extension plane of the handle housing.

6. The hand-held power tool according to claim 4, wherein:
the end of the handle housing faces the central web;
the end surrounds the drive housing in a substantially ring-like manner; and
the end is arranged at a distance from the drive housing radially and axially.

7. The hand-held power tool according to claim 6, wherein:
the end of the handle housing facing the central web is adjusted, in terms of shape, to the central web and/or the surface.

8. The hand-held power tool, of claim 7, wherein:
the drive housing has at least one air outlet opening which is at least partially covered by the handle housing as viewed in at least one main outlet direction of the at least one air outlet opening.

9. The hand-held power tool according to claim 8, wherein the drive housing has a motor housing which is arranged on the central web and has the at least one air outlet opening.

10. The hand-held power tool according to claim 8, wherein:
an opening for air to escape from the at least one air outlet opening is formed between the end of the handle housing facing the central web and the drive housing.

11. The hand-held power tool, according to claim 10, wherein:
the drive housing has a closed cable duct.

12. The hand-held power tool according to claim 11, wherein:
the drive housing has at least two housing shells between which the cable duct is arranged.

13. The hand-held power tool according to claim 12, wherein:
a first housing shell of the at least two housing shells forms a groove for the cable duct; and
a second housing shell of the at least two housing shells forms a lid for the cable duct.

14. The hand-held power tool according to claim 13, wherein:
the cable duct is arranged at least partially in the central web.

15. The hand-held power tool according to claim 1, wherein the hand-held power tool is configured as a hand-held grinding tool having a hand-held power tool apparatus.

16. The hand-held power tool according to claim 1, wherein the hand-held power tool is configured as a random orbital sander or an orbital sander.

17. A hand-held power tool, comprising:
a housing unit which has at least one handle housing and a drive housing which is coupled to the handle housing,
wherein
the drive housing has at least one air outlet opening which is at least partially covered by the handle housing as viewed in at least one main outlet direction of the at least one air outlet opening.

18. The hand-held power tool according to claim 17, wherein:
a central web is on a surface of an upper side of the drive housing, and raised relative to the surface;
the drive housing has a motor housing which is arranged on the central web (60a) and has the at least one air outlet opening; and
an opening for air to escape from the at least one air outlet opening is formed between an end of the handle housing facing the central web and the drive housing.

19. A hand-held power tool, comprising:
a housing unit which has at least one handle housing and a drive housing which is coupled to the handle housing,
wherein the drive housing has a closed cable duct.

20. The hand-held power tool of claim 19, wherein:
the drive housing has at least two housing shells between which the cable duct is arranged;
a first housing shell of the at least two housing shells forms a groove for the cable duct; and
a second housing shell of the at least two housing shells forms a lid for the cable duct.
